(19) United States
(12) Patent Application Publication
(10) Pub. No.: US 2022/0323847 A1
(43) Pub. Date: Oct. 13, 2022

(54) SYSTEM AND METHOD FOR SCORING COMBAT SPORTS

(71) Applicant: ZEMITA CO., LTD., Bucheon-si, Gyeonggi-do (KR)

(72) Inventor: Jin Jae LEE, Bucheon-si, Gyeonggi-do (KR)

(21) Appl. No.: 17/274,393

(22) PCT Filed: Jan. 5, 2021
(86) PCT No.: PCT/KR2021/000094

§ 371 Date: Mar. 8, 2021

(30) Foreign Application Priority Data
Jan. 6, 2020 (KR) 10-2020-0001577
Apr. 10, 2020 (KR) 10-2020-0044307

(51) Int. Cl. A63B 71/06

(52) U.S. Cl. CPC A63B 71/0605; A63B 2220/53; A63B 2220/83; A63B 2244/10; A63B 2220/13; A63B 2220/20

(57) ABSTRACT

A combat sports scoring system according to an embodiment of the present disclosure includes a striking object performing a striking action, a striking target including a scoring portion which is hit by the striking action, a control part configured to determine a valid hit and calculate a score on the basis of a hit signal output by the striking object and calculate a score, wherein the striking object includes a hit determination device configured to transmit the hit signal including information about the striking action to the control part.

### TECHNICAL FIELD

The present disclosure relates to a system and method for scoring combat sports, and more particularly, to a system and method for scoring combat sports that enables precise and accurate scoring.

### BACKGROUND ART

Recently, in combat sports in which hits are delivered to a human body, such as Taekwondo, Boxing, and Kung Fu, combat sports scoring may be performed using electronic devices attached to a striking object such as a hand or foot, and a striking target such as a body or head. When the striking object strikes a hit to the striking target, an electronic sensor or the like attached to the striking target determines whether the hit is made or not by measuring a strength of the hit and detecting a tag or the like that is embedded in the striking object and transmits a signal, thereby performing the combat sports scoring.

However, when the scoring is performed in such a manner, it is difficult to determine the exact magnitude of the hit struck by the striking object and the type of a striking action and to uniformly detect the hit in all parts of the striking object, and thus the accuracy of the scoring is reduced. The sensor attached to the striking target has a problem that measured values are not uniformly expressed according to the frequency of use.

### DESCRIPTION OF EMBODIMENTS

### Technical Problem

The present disclosure is directed to providing a system and method for scoring combat sports, capable of improving the accuracy and precision of the scoring and enabling uniform scoring by allowing a striking object to have a hit determination device.

The present disclosure is also directed to providing a combat sports system capable of improving the accuracy and precision of scoring, enabling uniform scoring, and allowing progress status and/or results of a match to be intuitively presented to spectators, by allowing a striking object to have a hit determination device.

The present disclosure is also directed to providing a combat sports scoring system capable of providing various scoring systems by combining the combat sports system with augmented reality and maximizing safety by reducing injuries to players.

### Solution to Problem

One aspect of the present disclosure provides a combat sports scoring system including a striking object performing a striking action, a striking target including a scoring portion which is hit by the striking action, a control part configured to determine a valid hit on the basis of a hit signal output by the striking object and calculate a score, wherein the striking object includes a hit determination device configured to output and transmit the hit signal including information about the striking action to the control part.

The hit determination device may include an inertial measurement unit (IMU) configured to output an inertial signal including three-dimensional information about the striking action and a communication unit configured to transmit the inertial signal received from the IMU to the control part.

The hit determination device may include a detection antenna configured to detect the striking target and output a detection signal including information about a degree of proximity between the striking object and the striking target, and the communication unit may transmit the detection signal received from the detection antenna to the control unit.

The control part may calculate a strength of the striking action on the basis of the inertial signal and determine a form of the striking action, calculate a proximity distance between the striking object and the striking target on the basis of the detection signal, and determine the valid hit and calculate a score by applying a predetermined rule of the combat sports to the strength of the striking action, the form of the striking action, and the proximity distance.

The striking target may include a detection target provided in the detection antenna, and the detection target may be located on the scoring portion.

The striking object may include a first striking object including a first detection antenna and a second striking object including a second detection antenna, wherein the first detection antenna may transmit a first call signal for activating the detection target, the second detection antenna may transmit a second call signal for activating the detection target, and the detection target may transmit a first response signal including first identification information to the first detection antenna in response to the first call signal and transmit a second response signal including second identification information to the second detection antenna in response to the second call signal.

The first detection antenna may output a first detection signal by decoding the first identification information on the basis of the first response signal, the second detection antenna may output a second detection signal by decoding the second identification information on the basis of the second response signal, and the control part may calculate a score by distinguishing the striking actions, which strike hits to different detection targets, on the basis of the first detection signal and the second detection signal.

The IMU may include at least one of an acceleration sensor (accelerometer), a gyro sensor (gyroscope), and a magnetic field sensor.

The detection target may include a radio frequency identification (RAD) tag, and the detection antenna may be an RFID detection antenna including an RFID reader.

The detection target may include a magnet, and the detection antenna may be a magnetic field detection antenna that detects a magnetic field.

Another aspect of the present disclosure provides a combat sports scoring method using a hit determination device included in a striking object and a striking target struck by the striking object, the method including performing a striking action by the striking object, striking a hit to a scoring portion of the striking target by the striking action, outputting, by the hit determination device, a hit signal including information about the striking action, and determining a valid hit on the basis of the hit signal and calculating a score.

The outputting of the hit signal by the hit determination device may include outputting an inertial signal including three-dimensional information about the striking action using an inertial measurement unit (IMU), and transmitting the inertial signal received from the IMU using a communication unit.

The outputting of the hit signal by the hit determination device may further include detecting the striking target using a detection antenna and outputting a detection signal including information about a degree of proximity between the striking object and the striking target, and transmitting the detection signal received from the detection antenna using the communication unit.

The hit signal may include the inertial signal and the detection signal, the outputting of the hit signal by the hit determination device may include calculating a strength of the striking action and determining a form of the striking action on the basis of the inertial signal, calculating a proximity distance between the striking object and the striking target on the basis of the detection signal, and the determining of the valid hit and the calculating of the score may include determining the valid hit and calculating the score by applying a predetermined rule of the combat sports to the strength of the striking action, the form of the striking action, and the proximity distance.

The outputting of the hit signal by the hit determination device may include detecting a detection target provided in the scoring portion of the striking target.

The striking object may include a first striking object including a first detection antenna and a second striking object including a second detection antenna, and the outputting of the hit signal may include transmitting, by the first striking object, a first call signal for activating the detection target using the first detection antenna, transmitting, by the second striking object, a second call signal for activating the detection target using the second detection antenna, and transmitting a first response signal including first identification information to the first detection antenna in response to the first call signal and transmitting a second response signal including second identification information to the second detection antenna in response to the second call signal using the detection target.

The method may include, after the transmitting of the first response signal and the second response signal, decoding the first identification information on the basis of the first response signal and outputting a first detection signal using the first detection antenna, decoding the second identification information on the basis of the second response signal and outputting a second detection signal using the second detection antenna, and calculating a score by distinguishing the striking actions, which strike hits to different detection targets, on the basis of the first detection signal and the second detection signal.

The IMU may include at least one of an acceleration sensor (accelerometer), a gyro sensor (gyroscope), and a magnetic field sensor.

The detection target may include a radio frequency identification (RFID) tag, and the detection antenna may be an RFID detection antenna including an RFID reader.

The detection target may include a magnet, and the detection antenna may be a magnetic field detection antenna that detects a magnetic field.

Another aspect of the present disclosure provides a combat sports scoring system including a sparring object, which includes a striking object, a striking target which is hit by a striking action of the striking object, and marker information of the striking object and the striking target, an image capturing unit configured to capture an image of the sparring object and recognize the marker information to generate a scoring target image, an augmented reality (AR) server including a hit information detection unit configured to detect hit information about the striking action, an image signal generation unit configured to generate an image signal for the scoring target image, and an AR output unit configured to generate a scoring image by synthesizing an image corresponding to the image signal with the scoring target image, and a display unit configured to display the scoring image.

The striking object may include a hit determination device, and the hit determination device may include an inertial measurement unit (IMU) configured to output an inertial signal including three-dimensional information about the striking action, a detection antenna configured to detect the striking target and output a detection signal including information about a degree of proximity between the striking object and the striking target, and a communication unit configured to transmit the inertial signal and the detection signal to the AR server.

The image signal generation unit may include a first image signal generation unit configured to generate a progress image signal, which is a basis of a progress image including a match status information, and a second image signal generation unit configured to generate an effect image signal that is a basis of an effect image, wherein the effect image may be an image visually representing whether the striking action is performed, whether a change has occurred, and changes in the image.

The sparring object may include a first punching stand on which a first hit determination device including first marker information is installed, and a first striking object that is configured to perform the striking action to the first punching stand and belongs to a first player, and the AR server may output a virtual striking object at a location corresponding to the first punching stand to generate the scoring image.

The hit determination device may include a first hit determination device including first marker information and a second hit determination device including second marker information, the sparring object may include a first sparring object including a first punching stand on which the first hit determination device is installed and a first striking object that performs a striking action to the first punching stand and belongs to a first player, and a second sparring object including a second punching stand on which the second hit determination device is installed and a second striking object that performs a striking action to the second punching stand and belongs to a second player, and the AR server may generate the scoring image on the basis of a first scoring target image generated by capturing the first sparring object and a second scoring target image generated by capturing the second sparring object.

### Advantageous Effects of Disclosure

According to embodiments of the present disclosure, a system and method for scoring combat sports can be provided, in which the accuracy and precision of scoring can be improved and uniform scoring can be enabled by allowing a striking object to have a hit determination device and a striking target to have a detection target.

According to embodiments of the present disclosure, the accuracy and precision of scoring can be improved and uniform scoring can be enabled by allowing a striking object to have a hit determination device and a striking target to have a detection target.

Further, progress status and/or results of combat sports scoring can be intuitively provided to players, referees, and/or spectators, and furthermore, the scoring can be automatically reflected in the scoring of a match in various and detailed forms.

In addition, various scoring systems can be implemented by combining the combat sports system with augmented reality, and safety can be maximized by reducing injuries to players.

### BRIEF DESCRIPTION OF DRAWINGS

FIG. 1 is a view illustrating a combat sports scoring system according to an embodiment of the present disclosure.

FIG. 2 is a configuration diagram illustrating the combat sports scoring system according to an embodiment of the present disclosure.

FIG. 3 is a diagram schematically illustrating some components of a hit determination device according to an embodiment of the present disclosure.

FIG. 4 is a diagram schematically illustrating a configuration of an approach detection device according to an embodiment of the present disclosure.

FIG. 5 is a view illustrating a hit determination device according to an embodiment of the present disclosure.

FIG. 6 is a view illustrating a hit determination device according to another embodiment of the present disclosure,

FIG. 7 is a view illustrating a striking target according to an embodiment of the present disclosure.

FIG. 8 is a flowchart for describing a combat sports scoring method according to an embodiment of the present disclosure.

FIG. 9 is a flowchart for describing some of the operations described with reference to FIG. 8 in more detail.

FIG. 10 is a flowchart for describing some of the operations described with reference to FIG. 9 in more detail.

FIG. 11 is a view schematically illustrating a combat sports system according to an embodiment of the present disclosure.

FIG. 12 is a block diagram illustrating the combat sports system according to an embodiment of the present disclosure in more detail.

FIG. 13 is a diagram more specifically illustrating the combat sports system according to an embodiment of the present disclosure from the perspective of a control part and a display part.

FIG. 14 is a diagram schematically illustrating some components of a hit determination device according to an embodiment of the present disclosure.

FIG. 15 is a diagram schematically illustrating a configuration of an approach detection device according to an embodiment of the present disclosure.

FIG. 16 is a block diagram schematically illustrating an output value generation unit according to an embodiment of the present disclosure,

FIG. 17 is a block diagram schematically illustrating an output value generation unit according to another embodiment of the present disclosure.

FIG. 18 is a diagram illustrating a configuration of a display image displayed by the display part according to an embodiment of the present disclosure.

FIG. 19 is a diagram illustrating one example of a progress image according to an embodiment of the present disclosure,

FIG. 20 is a diagram illustrating another example of the progress image according to an embodiment of the present disclosure.

FIG. 21 is a diagram illustrating another example of the progress image according to an embodiment of the present disclosure.

FIG. 22 is a diagram illustrating another example of the progress image according to an embodiment of the present disclosure.

FIG. 23 is a view illustrating the hit determination device according to an embodiment of the present disclosure.

FIG. 24 is a view illustrating a hit determination device according to another embodiment of the present disclosure.

FIG. 25 is a view illustrating a striking target according to an embodiment of the present disclosure.

FIG. 26 is a view schematically illustrating a combat sports scoring system according to an embodiment of the present disclosure.

FIG. 27 is a block diagram schematically illustrating a configuration of a user terminal according to an embodiment of the present disclosure.

FIG. 28 is a block diagram schematically illustrating a configuration of an augmented reality (AR) server according to an embodiment of the present disclosure,

FIG. 29 is a block diagram illustrating a configuration of a control unit of the AR server according to an embodiment of the present disclosure, in more detail.

FIG. 30 is a view schematically illustrating a combat sports scoring system according to another embodiment of the present disclosure.

FIG. 31 is an exemplary view illustrating a start screen of an output image of the combat sports scoring system according to an embodiment of the present disclosure.

FIGS. 32 and 33 are exemplary views each illustrating an output image of the combat sports scoring system according to an embodiment of the present disclosure.

FIG. 34 is an exemplary view illustrating a screen for controlling an output image of the combat sports scoring system according to an embodiment of the present disclosure.

FIG. 35 is a view schematically illustrating a combat sports scoring system according to another embodiment of the present disclosure.

FIGS. 36 and 37 are exemplary views each illustrating an output image of the combat sports scoring system according to an embodiment of the present disclosure.

FIG. 38 is a view schematically illustrating a configuration of a combat sports scoring system according to another embodiment of the present disclosure.

### MODE OF DISCLOSURE

While the present disclosure is susceptible to various modifications and alternative forms, specific embodiments thereof are shown by way of example in the drawings and will herein be described in detail. Advantages and features of the present disclosure and methods for accomplishing the same will be more clearly understood from embodiments described below with reference to the drawings. However, the present disclosure is not limited to the embodiments disclosed below but may be implemented in various forms.

Hereinafter, the embodiments of the present disclosure will be described below in detail with reference to the accompanying drawings, but when describing with reference to the drawings, equal or corresponding components will be referred to as the same reference numerals, and redundant descriptions thereof will be omitted.

The terms “˜ unit,” “˜ portion,” and “˜ part” described herein refer to a unit for processing at least one function or operation, which may be implemented in hardware, software, or a combination of hardware and software.

In the following embodiments, the terms “first,” “second,” and the like have been used to distinguish one component from another, rather than limitative in all aspects. In the following embodiments, singular forms are intended to include plural forms as well, unless the context clearly indicates otherwise. In the following embodiments, the terms such as “including,” “having,” and “comprising” are intended to indicate the existence of features or components disclosed in the specification, and are not intended to preclude the possibility that one or more other features or components may be added. For convenience of description, sizes of components shown in the drawings may be exaggerated or reduced. For example, since the size and form of each component illustrated in the drawing are arbitrarily shown for convenience of description, the present disclosure is not necessarily limited to those illustrated in the drawing.

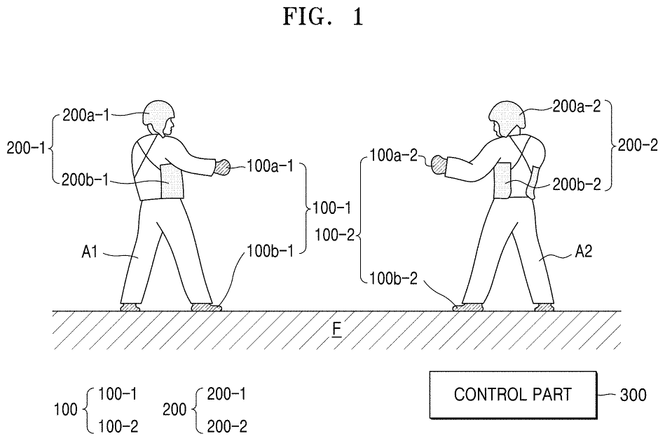

FIG. 1 is a view illustrating a combat sports scoring system according to an embodiment of the present disclosure. Referring to FIG. 1, the combat sports scoring system according to an embodiment of the present disclosure includes a striking object 100, a striking target 200, and a control part 300.

A first player A1 and a second player A2 who are participants of a match are located to face each other on a floor F, which is a competition area, and play a combat match. The combat sports or combat match of the present disclosure may be Taekwondo, Boxing, Kendo, or Wushu in which at least two participants are involved and compete, but the present disclosure is not limited thereto.

The striking object 100 refers to an object that performs a striking action against the striking target 200. The striking object 100 may include a striking object 100-1 of the first player A1 and a striking object 100-2 of the second player A2. The striking object 100-1 of the first player A1 may include a first-first striking object 100a-1 and a first-second striking object 100b-1, which are different parts. The striking object 100-2 of the second player A2 may include a second-first striking object 100a-2 and a second-second striking object 100b-2, which are different parts. As an example, the first-first striking object 100a-1 and the second-first striking object 100a-2 may each be a hand of each of the players A1 and A2, and the first-second striking object 100b-1 and the second-second striking object 100b-2 may each be a foot of each of the players A1 and A2.

The striking object 100 may be a striking means such as a hand, a foot, or the like and/or a sword, but the striking object 100 is not limited thereto.

The striking target 200 refers to a target as a scoring portion that is struck by the striking action of the striking object 100. The striking target 200 may include a striking target 200-1 of the first player A1 and a striking target 200-2 of the second player A2. The striking target 200-1 of the first player A1 may include a first-first striking target 200a-1 and a first-second striking target 200b-1, which are different parts. The striking target 200-2 of the second player A2 may include a second-first striking target 200a-2 and a second-second striking target 200b-2, which are different parts. As an example, the first-first striking target 200a-1 and the second-first striking target 200a-2 may each be a head of each of the players A1 and A2, and the first-second striking target 200b-1 and the second-second striking target 200b-2 may each be a body of each of the players A1 and A2.

The scoring portion of the striking target 200 may include various body parts, such as a head, a body, a thigh, and the like, but the scoring portion is not limited thereto.

The control part 300 may transmit a hit signal output from the striking object 100, determine a valid hit on the basis of the hit signal, and calculate a score of the match.

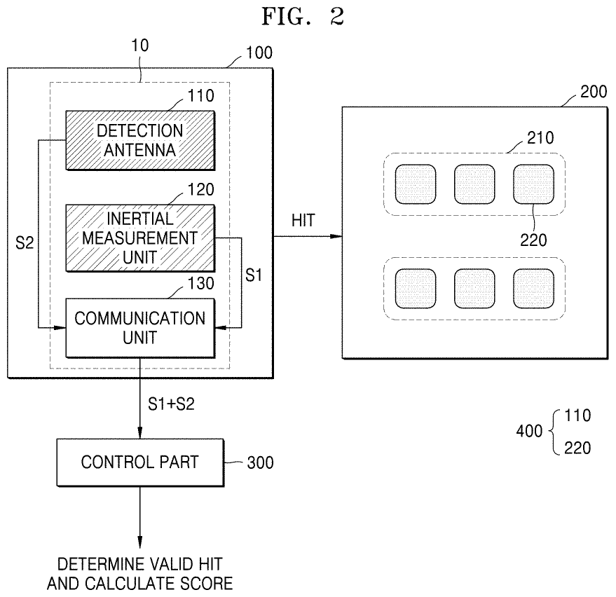

FIG. 2 is a configuration diagram illustrating the combat sports scoring system according to an embodiment of the present disclosure.

Referring to FIG. 2, the combat sports scoring system according to an embodiment includes the striking object 100, the striking target 200 to which a hit from the striking object 100 is delivered, and the control part 300, and each component is illustrated as a schematic block.

The striking object 100 includes a hit determination device 10 that outputs the hit signal including information about the striking action. The hit determination device 10 may output and transmit the hit signal to the control part 300.

The hit determination device 10 may include an inertial measurement unit (IMU) 120, a detection antenna 110, and a communication unit 130.

The IMU 120 may output an inertial signal S1 including three-dimensional (3D) information about the striking action of the striking object 100. The IMU 120 may three-dimensionally measure information about a strength of the hit or a striking form of the striking action using sensors embedded in the IMU 120.

The IMU 120 may include at least one of an acceleration sensor (accelerometer), a gyro sensor (gyroscope), and a magnetic field sensor.

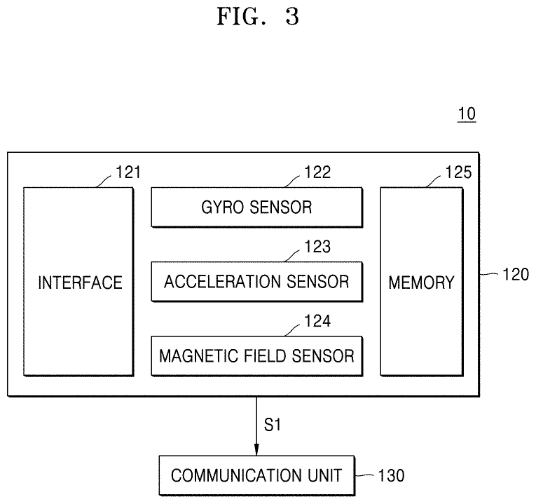

The IMU 120 will be described in more detail with reference to FIG. 3 to be described below.

The detection antenna 110 may output a detection signal S2 including information about a degree of proximity between the striking object 100 and the striking target 200. The detection antenna 110 may detect the striking target 200, specifically, a detection target 220 located at a scoring portion 210 of the striking target 200, using an approach detection device and output the detection signal S2.

The communication unit 130 may transmit the inertial signal S1 received from the IMU 120 and the detection signal S2 received from the detection antenna 110 to the control part 300. The above-described hit signal S1+S2 may be a concept including the inertial signal S1 and the detection signal S2. The hit signal may include the inertial signal S1 and the detection signal S2 in an unconverted form or in a form converted by a control unit (not shown) in the hit determination device 10.

The communication unit 130 may transmit the hit signal to the control part 300 using a wireless communication method such as Bluetooth, ZigBee, WiFi, or the like. The wireless communication method of the communication unit 130 does not limit the present disclosure.

The communication unit 130 of each of the plurality of striking objects 100a-1, 100b-1, 100a-2, and 100b-2 may convert the hit signals S1 and S2 into analog or digital signals in a form capable of wireless transmission, and transmit the converted signals to the control part 300. Depending on the striking object 100 to which the communication unit 130 belongs, the same or different types of communication units 130 may be used.

The hit determination device 10 may be provided in a form attached and/or embedded in a protector or the like that protects the striking object 100, but the form of the hit determination device 10 is not limited thereto, and the hit determination device 10 may be provided on the striking object 100 in various forms.

The striking target 200 may include the detection target 220, which is detected by the detection antenna 110. The detection target 220 may be embedded in and/or attached to the scoring portion 210 at which the hit is recognized as a score.

The detection target 220 may include at least one of a magnet and a radio frequency identification (RFD) tag. As an example, when the detection target 220 is an RFID tag, the detection antenna 110 may be an RFID detection antenna that detects a radio frequency (RF) signal using an RFID reader. The RFID reader may be connected to one terminal of the detection antenna 110. As another example, when the detection target 220 is a magnet, the detection antenna 110 may be an antenna that detects a magnetic field.

However, the detection target 220 is not limited thereto, and may be one of various elements to which information recognizable by the detection antenna 110 may be input and stored.

A plurality of detection targets 220 may be present in each of a plurality of scoring portions 210. The number of the detection targets 220 is not limited to those shown in FIG. 2.

Hereinafter, the detection antenna 110 and the detection target 220 may be collectively referred to as an approach detection device 400 and described.

The control part 300 may determine a valid hit on the basis of the hit signal output from the striking object 100 and calculate a score.

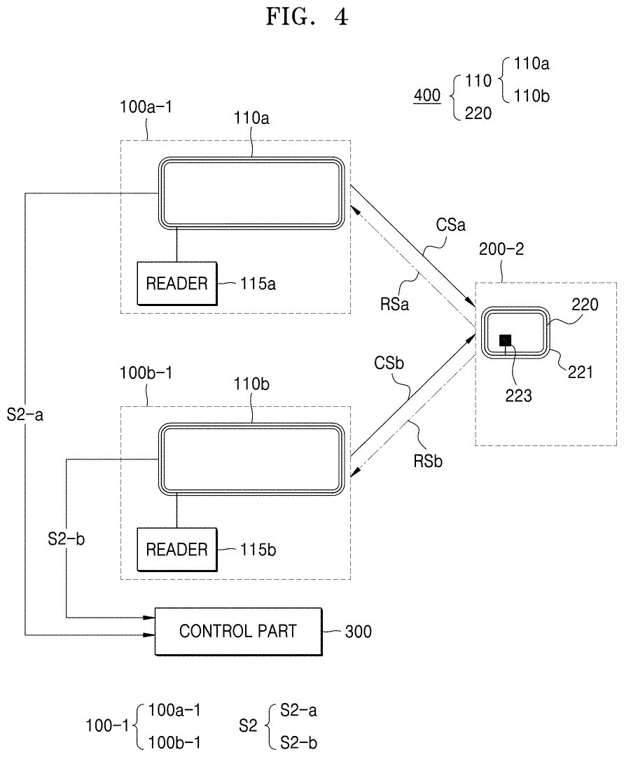

Specifically, the control part 300 may calculate a strength of the striking action on the basis of the inertial signal S1 and determine a form of the striking action. In addition, the control part 300 may calculate a proximity distance between the striking object 100 and the striking target 200 on the basis of the detection signal S2. Thereafter, a predetermined rule of the combat match may be applied to the strength of the striking action, the form of the striking action, and the proximity distance, and thus a valid hit may be determined and a score may be calculated. The inertial signal S1 and the detection signal S2 will be described in more detail with reference to FIGS. 3 and 4 to be described below.

According to an embodiment, the control part 300 may be included in the hit determination device 10, and in this case, the hit signal that is output by the communication unit 130 may be a signal N in which information about a score is already included by the control part 300. In this case, another control part (not shown) provided separately from the striking object 100 and the striking target 200 may function to display the hit signal N.

FIG. 3 is a diagram schematically illustrating some components of the hit determination device 10 according to an embodiment of the present disclosure.

The IMU 120 may output the inertial signal S1 including three-dimensional information about a striking action. The IMU 120 may include an interface 121, a gyro sensor (gyroscope) 122, an acceleration sensor (accelerometer) 123, a magnetic field sensor (magnetometer) 124, and a memory 125.

The interface 121 may serve to recognize pieces of information obtained by the sensors 122, 123, and 124, perform signal processing, and transfer or transmit the signal-processed information to an external element such as the communication unit 130.

The IMU 120 may include at least one of the gyroscope 122, the accelerometer 123, and the magnetometer 124, or may be configured by combining multiple axes of each of the sensors 122, 123, and 124. As an example, at least one of the gyroscope 122, the accelerometer 123, and the magnetometer 124 may be a three-axis sensor.

The gyroscope 122 may measure rotational inertia and/or rotation rate (an example of a unit is deg/sec) using an angular velocity of the striking object 100, the accelerometer 123 may measure movement inertia (an example of a unit is g (where 1 g=9.8 m/s²)) of the striking object 100 using acceleration of the striking object 100, and the magnetometer 124 may measure an azimuth angle of the striking object 100.

For example, a control unit (not shown) of the IMU 120 may obtain posture information, which includes information about a roll angle, a pitch angle, and a yaw angle of the striking object 100, speed information, and rotation information by respectively using the gyroscope 122, the accelerometer 123, and the magnetometer 124. Thereafter, the control unit (not shown) of the IMU 120 may generate the inertial signal S1 including information about the strength of the hit and the striking action of the striking object 100 on the basis of the posture information, the speed information, and the rotation information.

The IMU 120 may obtain information such as speed, direction, gravity, acceleration, or the like of the striking object 100 using the sensors 122, 123, and 124 to clearly identify the striking action. In other words, the IMU 120 may generate the inertial signal S1 that includes information about the strength or various movements of the striking action of the striking object 100 in three-dimensional directions including an X-axis, a Y-axis, and a Z-axis.

According to an embodiment, the information about the strength of the striking action may be calculated using a signal output by a separately provided strength measuring device (not shown), and may also be calculated using both the IMU 120 described above and the strength measuring device.

The memory 125 may perform a function of temporarily or permanently storing all types of data to be received or processed by all of the devices provided in the IMU 120 such as the interface 121 and the sensors 122, 123, and 124. The memory 125 is a computer-readable recording medium, and may include a random access memory (RAM), a read only memory (ROM), and a permanent mass storage device such as a disk drive. Alternatively, the memory 125 may include a magnetic storage medium or a flash storage medium, but the scope of the present disclosure is not limited thereto.

The control part 300 (see FIGS. 1 and 2) according to an embodiment may calculate a strength of the striking action on the basis of the inertial signal S1 and determine a form of the striking action. In the case of the combat match, scores given to various actions of the striking object 100 may be different. Here, according to the IMU 120 according to one embodiment, the type/form of the striking action may be determined and the strength of the hit may be calculated on the basis of the inertial signal S1, so that the striking action may be clearly identified. Thereafter, scoring the combat match may be performed through a method of applying a predetermined rule of the combat match to the strength of the hit and the striking form, determining a valid hit, and calculating a score. Here, when the information about the striking action, which is analyzed through the control part 300, does not match the predetermined rule of the combat match, the hit may not be identified as a valid hit and may not be scored.

As described above, according to the combat sports scoring system according to an embodiment of the present disclosure, accurate and precise scoring is possible by clearly identifying the striking action of the striking object 100 through the IMU 120.

The IMU 120 may be provided at one end of the striking object 100 to ensure free movement of the striking object 100. As an example, the one end may be a wrist when the striking object 100 is a hand, and may an ankle when the striking object 100 is a foot. Alternatively, the IMU 120 may be provided at one end of the striking object 100 by being attached on a protector worn on the striking object 100.

The sensors included in the IMU 120 are not limited to the sensors described above, and may further include a pressure and/or impact detection sensor, or may be configured in a form of combining various types of sensors to obtain information about various physical quantities related to the striking action.

FIG. 4 is a diagram schematically illustrating a configuration of the approach detection device 400 according to an embodiment of the present disclosure. In FIG. 4, a system including the striking objects 100a-1 and 100b-1 (i.e., 100-1) of the first player A1 and the striking target 200-2 of the second player A2 will be described as an example.

The striking object 100-1 may include the first striking object 100a-1 including a first detection antenna 110a, and the second striking object 100b-1 including a second detection antenna 110b. The detection target 220 is located on a scoring portion of the striking target 200-2. The detection target 220 may be a concept including different detection targets 220 provided at different striking targets. In addition, a plurality of detection targets 220 may be present on the scoring portion, but for convenience of description, one detection target 220 is illustrated in FIG. 4.

The first detection antenna 110a may transmit a first call signal CSa to activate the detection target 220, and the second detection antenna 110b may transmit a second call signal CSb to activate the detection target 220. Here, the first call signal CSa and the second call signal CSb may be received by the same detection target 220 or may be respectively received by different detection targets 220.

The detection target 220 may transmit a first response signal RSa including first identification information to the first detection antenna 110a in response to the first call signal CSa, and may transmit a second response signal RSb including second identification information to the second detection antenna 110b in response to the second call signal CSb. Similarly, the first response signal RSa and the second response signal RSb may be transmitted by the same detection target 220 or may be respectively transmitted by different detection targets 220.

The detection target 220 may include a memory chip 223 in which the identification information is stored and an antenna 221 connected to the memory chip 223. The memory chip 223 may include identification information only for distinguishing the striking targets 200, or may further include identification information for distinguishing the players A1 and A2 to which the detection targets 220 are provided.

Thereafter, the first detection antenna 110a may decode the first identification information on the basis of the first response signal RSa and output and transmit a first detection signal S2-a to the control part 300. Similarly, the second detection antenna 110b may decode the second identification information on the basis of the second response signal RSb and output and transmit a second detection signal S2-b to the control part 300. Here, the response signals RSa and RSb may be transmitted to the control part 300 through the communication unit 130.

The detection antennas 110a and 110b may recognize the response signals RSa and RSb, which are transmitted by the detection target 220, through readers 115a and 115b. The readers 115a and 115b may decode the identification information stored by the memory chip 223 of the detection target 220 to generate the detection signal S2, and transmit the detection signal S2 to the control part 300.

As an example, when the detection target 220 is an RFID tag, the readers 115a and 115b may be RFID readers, and the detection antennas 110a and 110b may be RFID detection antennas. In this case, the response signals RSa and RSb may be RF signals. As another example, when the detection target 220 is a magnet, the detection antennas 110a and 110b may be magnetic field detection antennas, and the response signals RSa and RSb may be magnetic field signals.

Thereafter, the control part 300 may calculate a score by distinguishing the striking actions, which strike hits to different detection targets 220, on the basis of the first detection signal S2-a and the second detection signal S2-b.

According to an embodiment, even when different striking objects 100a-1 and 100b-1 strike the hits to the detection target 220 including the same identification information, the striking object 100a-1 or 100b-1 may convert the response signal RSa or RSb received through the detection antenna 110a or 110b to output the detection signal S2, through which the striking objects 100a-1 and 100b-1 may be identified, using a control unit (not shown) included in each of the striking objects 100a-1 and 100b-1. In this case, the control part 300 may calculate the score by distinguishing the striking actions performed by different striking objects 100a-1 and 100b-1.

In a case in which the striking object 100 includes the detection target 220, and the striking target 200 includes the detection antenna 110, there may be a limitation in that it is difficult to determine all valid hits because it is difficult to detect a striking action performed by a part of the striking object 100 in which the detection target 220 is not provided. In addition, depending on the location of the striking target 200 provided with the detection antenna 110, there may be a blind spot in which the detection target 220 is not recognized, and thus a problem that a hit is not recognized as a valid hit may also occur when the speed of the striking action of the striking object 100 is high.

However, according to the combat sports scoring system according to an embodiment of the present disclosure, entire valid hits for the scoring portions of the striking target 200 may be accurately and uniformly determined by detecting the detection target 220 of the striking target 200 using the detection antenna 110 provided to the striking object 100. In addition, by providing the detection antenna 110 to each of all the striking objects 100, it is possible to determine whether the striking object 100 is close to the striking target 200, thereby minimizing errors in scoring the combat match.

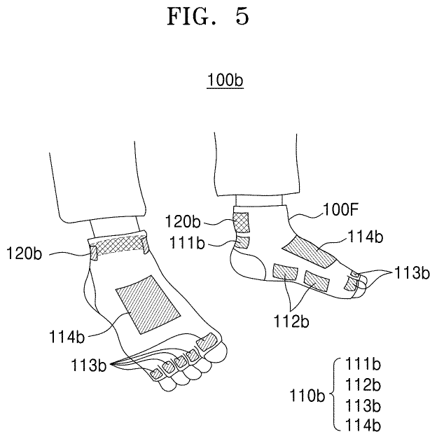

FIG. 5 is a view illustrating a hit determination device according to an embodiment of the present disclosure. Hereinafter, descriptions of content that are the same as those described above with reference to FIGS. 1 to 4 will be briefly given or omitted and will be given with reference to FIGS. 1 to 4 together.

In FIG. 5, a second striking object 100b is illustrated, and the second striking object 100b may be a concept including the first-second and second-second striking objects 100b-1 and 100b-2 of the players A1 and A2. Hereinafter, a case in which the second striking object 100b is a foot will be described as an example.

A second protector 100F may be worn on the second striking object 100b. An IMU 120b and a detection antenna 110b may be provided in a form of being embedded in or attached to the second protector 100F.

The IMU 120b may be provided on an ankle to ensure free movement of the foot. The detection antenna 110b may also be provided at a part of the second striking object 100b, to which the detection target 220 is difficult to be attached in the past, so that all scoring portions of the striking target 200 may be constantly and uniformly detected. For example, detection antennas 111b, 112b, and 113b may be provided not only on an instep 114b, but also on at least one part selected from among a heel 111b, a side of the foot 112b, and a toe 113b, and may also be provided on other parts of the foot. Accordingly, it is possible to minimize the omission of valid hits in the combat match, so that accurate scoring is possible.

According to another embodiment, the detection antennas 110b may also be provided integrally on the entire foot, mainly on the instep (114a), without being separately provided for each part as described above, thereby identifying the striking object 100b in which the detection antennas 110b are provided.

As an example, the detection antennas 111b, 112b, 113b, and 114b (i.e., 110b) shown in FIG. 5 may each be provided in a form of an antenna forming a closed curved line like the detection antenna 110b shown in FIG. 4.

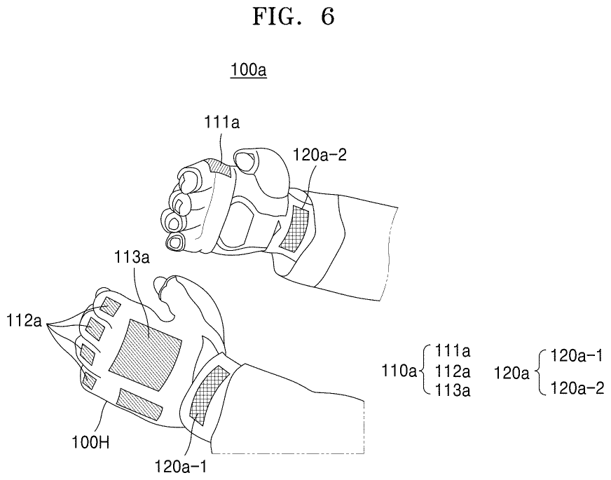

FIG. 6 is a view illustrating a hit determination device according to another embodiment of the present disclosure.

In FIG. 6, a first striking object 100a is illustrated, and the first striking object 100a may be a concept including the first-first and second-first striking objects 100a-1 and 100a-2 of the players A1 and A2. Hereinafter, a case in which the first striking object 100a is a hand will be described as an example.

A first protector 100H may be worn on the first striking object 100a. An IMU 120a and a detection antenna 110a may be provided in a form of being embedded in or attached to the first protector 100H.

The IMU 120a may be provided on a wrist to ensure free movement of the hand. In more detail, the IMU 120a may be provided on an outer part (120a-1) of the wrist or may be provided on an inner part (120a-2) of the wrist.

The detection antenna 110a may also be provided at a part of the first striking object 100a, to which the detection target 220 is difficult to be attached in the past, so that all scoring portions of the striking target 200 may be constantly and uniformly detected. For example, detection antennas 111a and 112a may be provided not only on a back of the hand 113a, but also on at least one part selected from fingers 112a and a side of the hand 111a, and may also be provided on other parts of the hand.

According to another embodiment, the detection antennas 110a may be provided integrally on the entire hand, mainly on the back of the hand (113a), without being separately provided for each part as described above, thereby identifying the striking object 100a in which the detection antennas 110a are provided.

In addition, as an example, the detection antennas 111a, 112a, and 113b (i.e., 110a) shown in FIG. 6 may be provided in a form of an antenna forming a closed curved line like the detection antenna 110a shown in FIG. 4.

As an example, in FIGS. 5 and 6, the IMUS 120a and 120b may be provided using an impact mitigating material to improve durability, so that the strength of a hit or the like may be accurately detected. Further, as an example, the detection antennas 110a and 110b may be designed to use a conductive fabric.

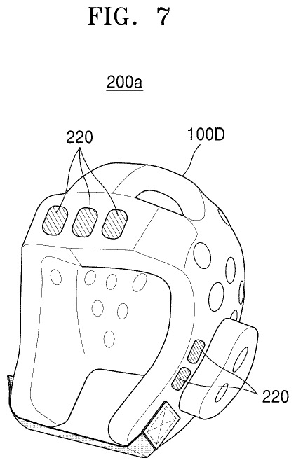

FIG. 7 is a view illustrating a striking target according to an embodiment of the present disclosure. In FIG. 7, a first striking target 200a is illustrated, and the first striking target 200a may be a concept including the first-first and second-first striking targets 200a-1 and 200a-2 of the players A1 and A2. Hereinafter, a case in which the first striking target 200a is a head will be described as an example.

A third protector 100D may be worn on the first striking target 200a. A detection target 220 may be provided in a form of being embedded in or attached to the third protector 100D.

The detection antenna 110 provided in the striking object 100 may detect whether the detection target 220 is in proximity using a magnetic field or an RF communication method even when the detection target 220 is spaced apart from the detection antenna 110 by a certain distance. According to an embodiment of the present disclosure, the detection target 220 is provided around a part P of the striking target 200, which is a part where it is difficult to directly detect a valid hit such as a front surface of the face, so that the valid hit may be determined even in the part P. As an example, a separation distance at which the detection antenna 110 may detect the detection target 220 may be about 15 cm or less, and specifically, about 10 cm or less.

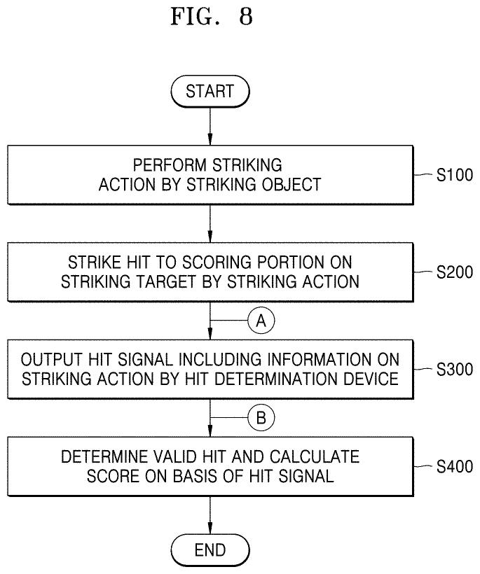

FIG. 8 is a flowchart for describing a combat sports scoring method according to an embodiment of the present disclosure. Descriptions of content that are the same as those described above will be briefly given or omitted, and the same components may be described using the same reference numerals.

The combat sports scoring method according to an embodiment may include the following operations.

A striking object 100 may perform a striking action (S100). A hit may be struck to a scoring portion 210 on a striking target 200 by the striking action (S200). A hit determination device 10 may output hit signals S1 and S2 including information about the striking action (S300).

Thereafter, valid hits may be determined on the basis of the hit signals S1 and S2, and a score may be calculated (S400),

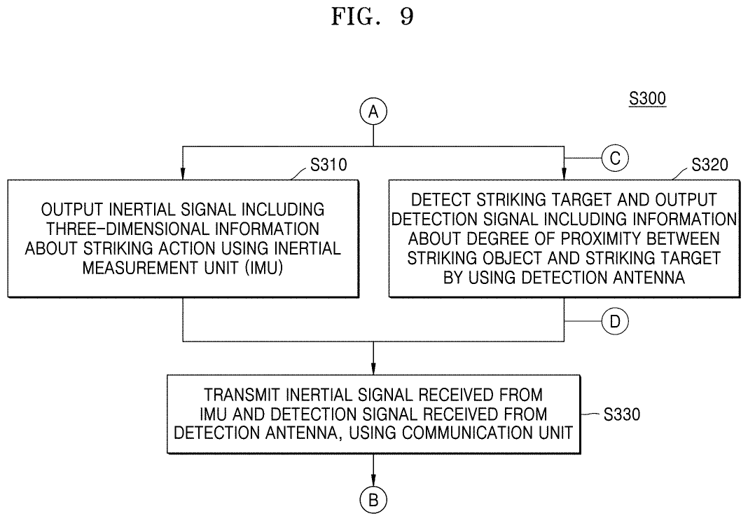

FIG. 9 is a flowchart for describing operation S300, which is a part of the operations described with reference to FIG. 8, in more detail. Operation S300 of outputting the hit signals by the hit determination device 10 may include the following operations.

An inertial signal S1 including 3D information about the striking action may be output using an IMU 120 (S310). In addition, by using the detection antenna 110, the striking target 220 may be detected and a detection signal S2 including information about a degree of proximity between the striking object 100 and the striking target 200 may be output (S320).

Thereafter, the inertial signal S1 received from the IMU 120 and the detection signal S2 received from the detection antenna 110 may be transmitted to the outside using a communication unit 130 (S330).

The hit signals may include the inertial signal S1 and the detection signal S2, or may include signals in which the inertial signal S1 and the detection signal S2 are converted by specific signal processing.

More specifically, on the basis of the inertial signal S1, a strength of the striking action is calculated and a form of the striking action is determined, so that the striking action may be clearly identified. In addition, a proximity distance between the striking object 100 and the striking target 200 may be calculated on the basis of the detection signal S2.

In operation S400 of determining a valid hit and calculating a score (see FIG. 8), the valid hit may be determined and the score may be calculated by applying a predetermined rule of a combat match to the strength of the striking action, the form of the striking action, and the proximity distance.

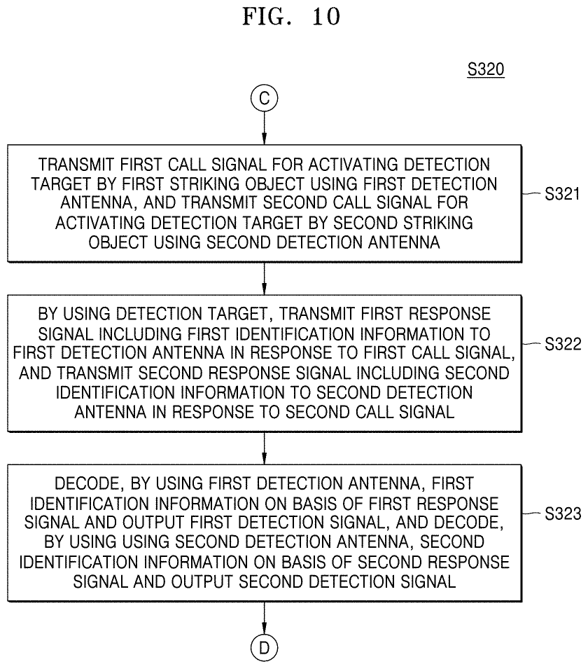

FIG. 10 is a flowchart for describing operation S320, which is a part of the operations described with reference to FIG. 9, in more detail. In operation S320 of outputting the detection signal S2, a detection target 220 provided in the scoring portion 210 of the striking target 200 may be detected, and operation S320 may include the following operations.

For example, the striking object 100 may include a first striking object 100a including a first detection antenna 110a, and a second striking object 100b including a second detection antenna 110b.

The first striking object 100a may transmit a first call signal CSa for activating the detection target 220 using the first detection antenna 110a, and the second striking object 100b may transmit a second call signal CSb for activating the detection target 220 using the second detection antenna 110b (S321).

By using the detection target 220, a first response signal RSa including first identification information may be transmitted to the first detection antenna 110a in response to the first call signal CSa, and a second response signal RSb including second identification information may be transmitted to the second detection antenna 110b in response to the second call signal CSb (S322).

Thereafter, the first identification information may be decoded on the basis of the first response signal RSa, and a first detection signal S2-a may be output using the first detection antenna 110a. In addition, the second identification information may be decoded on the basis of the second response signal RSb, and a second detection signal S2-b may be output using the second detection antenna 110b (S323).

Thereafter, a score may be calculated by distinguishing the striking actions, which strike hits to different detection targets 220, on the basis of the first detection signal S2-a and the second detection signal S2-b.

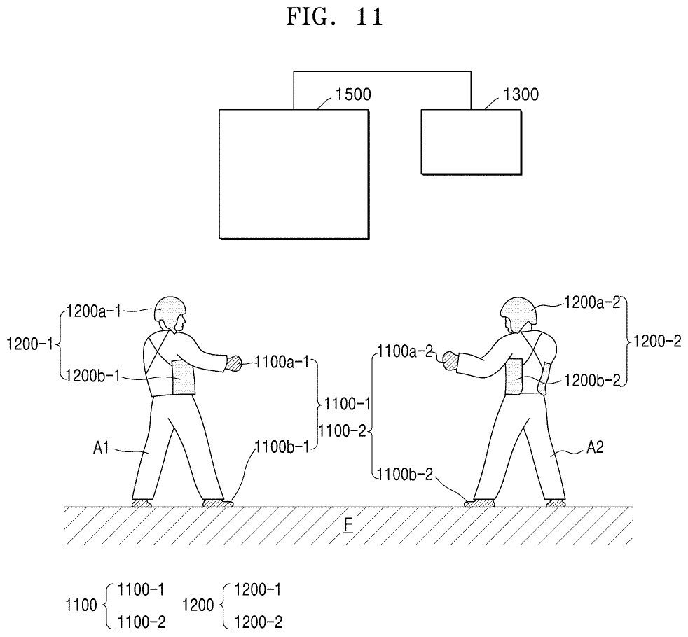

FIG. 11 is a view schematically illustrating a combat sports system according to an embodiment of the present disclosure. Referring to FIG. 11, the combat sports system according to an embodiment of the present disclosure includes a striking object 1100, a striking target 1200, a control part 1300, a display part 1500.

A first player 1A1 and a second player 1A2 who are participants of a match are located to face each other on a floor F, which is a competition area, and play a combat match. The combat sports or combat match of the present disclosure may be Taekwondo, Boxing, Kendo, or Wushu in which at least two participants are involved and compete, but the present disclosure is not limited thereto.

The striking object 1100 is an object that performs a striking action on the striking target 1200. The striking object 1100 may include a striking object 1100-1 of the first player 1A1 and a striking object 1100-2 of the second player 1A2. The striking object 1100-1 of the first player 1A1 may include a first-first striking object 1100a-1 and a first-second striking object 1100b-1, which are different parts. The striking object 1100-2 of the second player 1A2 may include a second-first striking object 1100a-2 and a second-second striking object 1100b-2, which are different parts. As an example, the first-first striking object 1100a-1 and the second-first striking object 1100a-2 may each be a hand of each of the players 1A1 and 1A2, and the first-second striking object 1100b-1 and the second-second striking object 1100b-2 may each be a foot of each of the players 1A1 and 1A2.

The striking object 1100 may be a striking means such as a hand, a foot, or the like and/or a sword, but the striking object 1100 is not limited thereto.

The striking target 1200 refers to a target as a scoring portion that is struck by the striking action of the striking object 1100. The striking target 1200 may include a striking target 1200-1 of the first player 1A1, and a striking target 1200-2 of the second player 1A2. The striking target 1200-1 of the first player 1A1 may include a first-first striking target 1200a-1 and a first-second striking target 1200b-1, which are different parts. The striking target 1200-2 of the second player 1A2 may include a second-first striking target 1200a-2 and a second-second striking target 1200b-2, which are different parts. As an example, the first-first striking target 1200a-1 and the second-first striking target 1200a-2 may be heads of the players 1A1 and 1A2, respectively, and the first-second striking target 1200b-1 and the second-second striking target 1200b-2 may be bodies of the players 1A1 and 1A2, respectively.

The scoring portion of the striking target 1200 may include various body parts, such as a head, a body, a thigh, and the like, but the scoring portion is not limited thereto.

The display part 1500 may be disposed above one side of the floor F and display information about the status of each of the players 1A1 and 1A2 in the combat match. The control part 1300 may be electrically connected to the display part 1500.

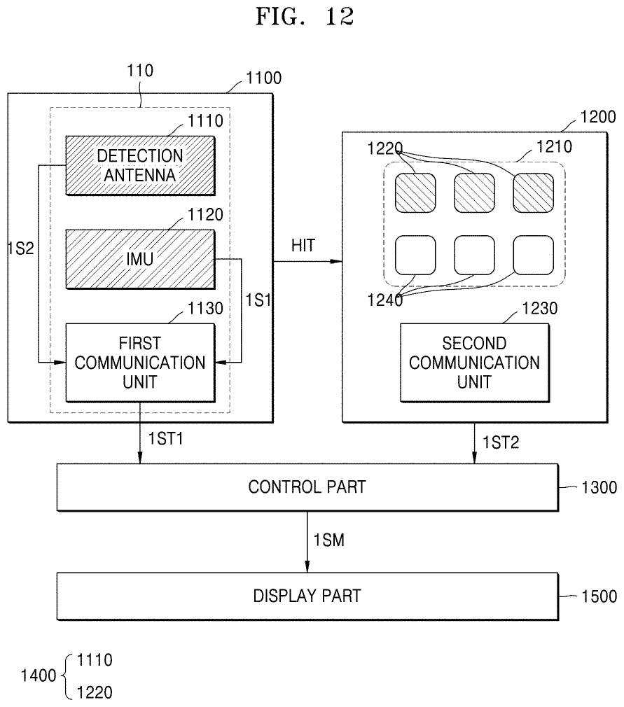

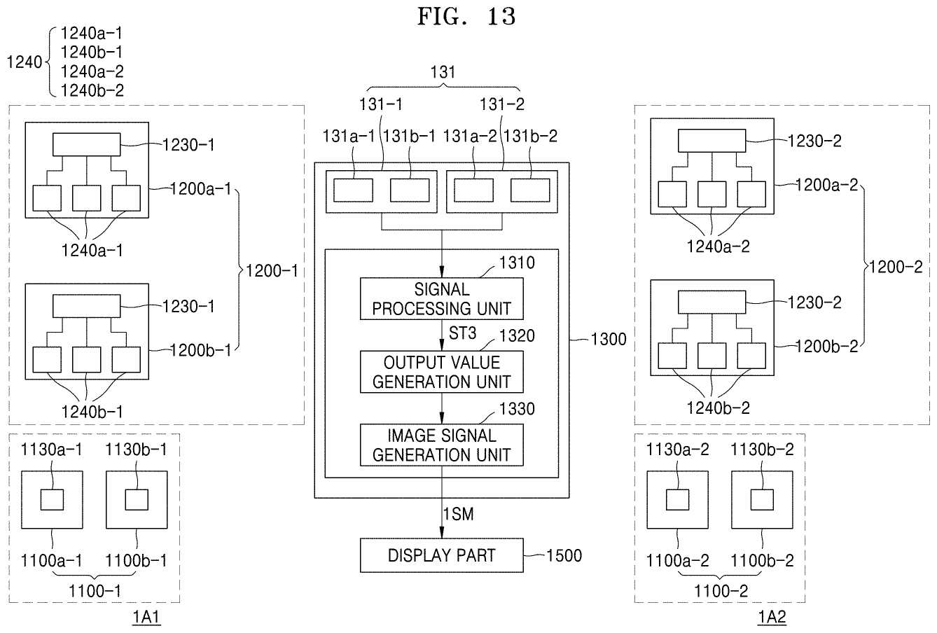

The control part 1300 may determine valid hits on the basis of hit signals output from the striking object 1100 and/or the striking target 1200, and calculate a score of the match. The control part 1300 may transmit a signal, thus processed by the above operation, to the display part 1500, and display information related to content of the match through the display part 1500. The control part 1300 and the display part 1500 will be described in more detail with reference to FIGS. 12 and 13 to be described below.

FIG. 12 is a block diagram illustrating the combat sports system according to an embodiment of the present disclosure in more detail.

Referring to FIG. 12, the combat sports system according to an embodiment includes the striking object 1100, the striking target 1200 to which a hit from the striking object 1100 is delivered, the control part 1300, and the display part 1500, and each component is illustrated as a schematic block.

The striking object 1100 includes a hit determination device 110 that outputs a first hit signal 1ST1 including first information related to a striking action. The hit determination device 110 may output and transmit the first hit signal 1ST1 to the control part 1300. The first information may include a strength of the striking action, a type (form 1) of the striking action, information about a proximity distance between the striking object 1100 the striking target 1200, and the like, and will be described in more detail in a related part to be described below.

The hit determination device 110 may include an IMU 1120, a detection antenna 1110, and a first communication unit 1130.

The IMU 1120 may output an inertial signal 1S1 including 3D information about the striking action of the striking object 1100. The IMU 1120 may three-dimensionally measure information about a strength of the hit or a striking form of the striking action using sensors embedded in the IMU 1120.

The IMU 1120 may include at least one of an acceleration sensor (accelerometer), a gyro sensor (gyroscope), and a magnetic field sensor.

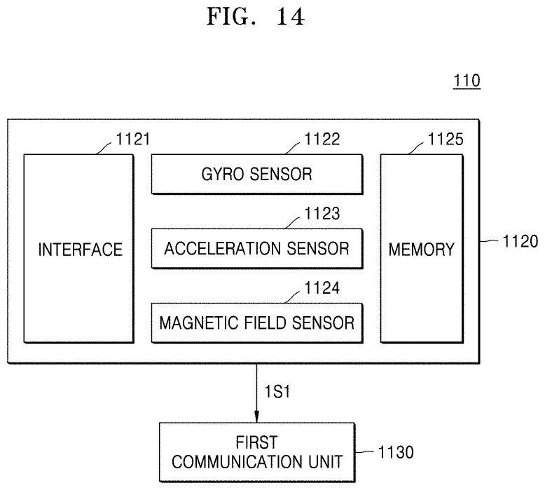

The IMU 1120 will be described in more detail with reference to FIG. 14 to be described below.

The detection antenna 1110 may output a detection signal 1S2 including information about a degree of proximity between the striking object 1100 and the striking target 1200. The detection antenna 1110 may detect the striking target 1200, specifically, a detection target 1220 located at a scoring portion 1210 of the striking target 1200, using an approach detection device and output the detection signal 1S2.

The first communication unit 1130 may transmit the inertial signal 1S1 received from the IMU 1120 and the detection signal 132 received from the detection antenna 1110 to the control part 1300. The first hit signal 1ST1 may be a concept including the inertial signal 131 and the detection signal 132. In other words, the first hit signal 1ST1 may include information about the strength of the striking action and the form of the striking action, which are calculated and determined on the basis of the inertial signal 1S1. In addition, the first hit signal 1ST1 may also include information about a proximity distance between the striking object 1100 and the striking target 1200, which is calculated on the basis of the detection signal 1S2.

The first hit signal 1ST1 may be obtained by summing each of the inertial signal 1S1 and the detection signal 1S2 in an unconverted form and then converted and processed in the subsequent control part 1300, or may include signals 1S1 and 1S2 in a form converted by a control unit (not shown) in the hit determination device 110.

The first communication unit 1130 may transmit the first hit signal 1ST1 to the control part 1300 using a wireless communication method such as Bluetooth, ZigBee, WiFi, or the kike. The wireless communication method of the first communication unit 1130 does not limit the present disclosure.

The communication unit 1130 of each of the plurality of striking objects 1100a-1, 1100b-1, 1100a-2, and 1100b-2 (i.e., 1101-1 and 1100-2) may convert the first hit signal 1ST1 into an analog or digital signal in a form capable of wireless transmission, and transmit the converted signal to the control part 1300. Depending on the striking object 1100 to which the first communication unit 1130 belongs, the same or different types of first communication units 1130 may be used.

The hit determination device 110 may be provided in a form attached and/or embedded in a protector or the like that protects the striking object 1100, but the form of the hit determination device 110 is not limited thereto, and the hit determination device 110 may be provided on the striking object 1100 in various forms.

The striking target 1200 may include the detection target 1220, which is detected by the detection antenna 1110, a sensing unit 1240, and a second communication unit 1230. The striking target 1200 may detect a striking action from the striking object 1100 and generate a second hit signal 1ST2.

The detection target 1220 may be embedded in and/or attached to the scoring portion 1210 at which the hit is recognized as a score. The detection target 1220 may include at least one of a magnet and an RFID tag. As an example, when the detection target 1220 is an RFID tag, the detection antenna 1110 may be an RFID detection antenna that detects an RF signal using an RFID reader. The RFID reader may be connected to one terminal of the detection antenna 1110. As another example, when the detection target 1220 is a magnet, the detection antenna 1110 may be an antenna that detects a magnetic field.

However, the detection target 1220 is not limited thereto, and may be one of various elements to which information recognizable by the detection antenna 1110 may be input and stored.

In each of a plurality of scoring portions 1210, at least one detection target 1220 may be present, or a plurality of detection targets 1220 may be present. The number of the detection targets 1220 is not limited to those shown in FIG. 12.

At least one sensing unit 1240 may be embedded in and/or attached to the scoring portion 1210 and may detect a hit delivered to each striking target 1200 to generate the second hit signal 1ST2. A plurality of sensing units 1240 may be provided and installed at different positions, and may generate second hit signals 1ST2 that are distinguished from each other. Even when a plurality of sensing units 1240 are further subdivided and installed on the same type of striking target, the plurality of sensing units 1240 may generate the second hit signals 1ST2 that are distinguished from each other. However, the plurality of sensing units 1240 are not limited thereto and may generate the same second hit signal 1ST2.

The second communication unit 1230 may transmit the second hit signal 1ST2 generated by the sensing unit 1240 to the control part 1300. The same description as described above in connection with the first communication unit 1130 may also be applied to the second communication unit 1230. The wireless communication method of the second communication unit 1230 does not limit the present disclosure. Depending on the striking target 1200 to which the second communication unit 1230 belongs, the same or different types of communication units may be used.

The sensing unit 1240 and the second communication unit 1230 will be further described with reference to FIG. 13 to be described below.

Hereinafter, the detection antenna 1110 and the detection target 1220 may be collectively referred to as an approach detection device 1400 and described.

The control part 1300 may generate an output value on the basis of the first hit signal 1ST1, which is output from the striking object 1100, and the second hit signal 1ST2, may generate an image signal 1SM corresponding to the output value, and may transmit the image signal 1SM to the display part 1500.

Specifically, the control part 1300 may calculate a strength of the striking action on the basis of the inertial signal 1S1 included in the first hit signal 1ST1 and determine a form of the striking action. In addition, the control part 1300 may calculate a proximity distance between the striking object 1100 and the striking target 1200 on the basis of the detection signal 1S2 included in the first hit signal 1ST1. As described above, the control part 1300 may extract first information from the first hit signal 1ST1 and extract second information from the second hit signal 1ST2, which is received from the striking target 1200, to generate a third hit signal 1ST3. Thereafter, the control part may generate an output value corresponding to the third hit signal 1ST3 and generate the image signal 1SM corresponding to the output value.

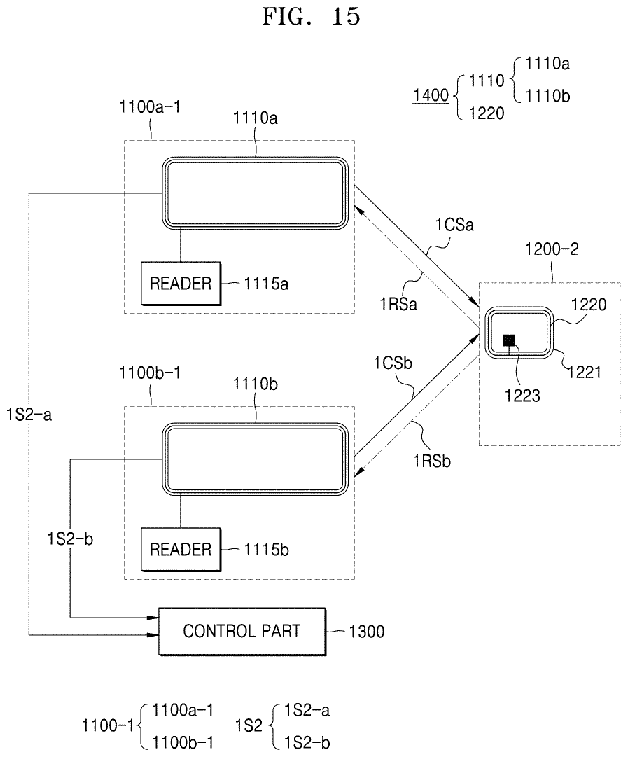

The inertial signal 1S1 and the detection signal 1S2 will be described in more detail with reference to FIGS. 14 and 15 to be described below.

According to an embodiment, the hit determination device 110 may include a separate control unit (not shown), and the first hit signal 1ST1 output by the first communication unit 1130 may be a signal in which information about a score is already included by the separate control unit (not shown).

The display part 1500 may generate and display an image corresponding to the image signal 1SM received from the control part 1300.

FIG. 13 is a diagram more specifically illustrating the combat sports system according to an embodiment of the present disclosure from the perspective of the control part 1300 and the display part 1500.

Referring to FIG. 13, the striking object 1100-1 and the striking target 1200-1 of the first player 1A1, the striking object 1100-2 and the striking target 1200-2 of the second player 1A2, and the control part 1300 and the display part 1500 are illustrated.

The first-first striking target 1200a-1 may include at least one first-first sensing unit 1240a-1 and a second-first communication unit 1230-1. The first-second striking target 1200b-1 may include at least one first-second sensing unit 1240b-1 and a second-first communication unit 1230-1. The first-first sensing unit 1240a-1 and the first-second sensing unit 1240b-1 may detect hits delivered to striking targets 1200a-1 and 1200b-1, respectively, to generate a second-first hit signal that is one type of the second hit signal 1ST2. Here, a plurality of first-first sensing units 1240a-1 may generate a plurality of hit signals, respectively, that are distinguished from each other, and a plurality of first-second sensing units 1240b-1 may generate a plurality of hit signals, respectively, that are distinguished from each other. However, the present disclosure is not necessarily limited thereto, and the first-first sensing units 1240a-1 and the first-second sensing units 1240b-1 may all generate the same hit signal.

The second-first communication unit 1230-1 may transmit the hit signals generated by the sensing units 1240a-1 and 1240b-1 to a first receiving unit 131-1, for example, a first-first receiving unit 131a-1, of the control part 1300. The second-first communication unit 1230-1 provided in each of the first-first striking target 1200a-1 and the first-second striking target 1200b-1 may use the same or different types of transmission units.

The second-first striking target 1200a-2 may include at least one second-first sensing unit 1240a-2 and a second-second communication unit 1230-2. The second-second striking target 1200b-2 may include at least one second-second sensing unit 1240b-2 and a second-second communication unit 1230-2. The second-first sensing unit 1240a-2 and the second-second sensing unit 1240b-2 may detect hits delivered to striking targets 1200a-2 and 1200b-2, respectively, to generate a second-second hit signal that is one type of the second hit signal 1ST2. Here, a plurality of second-first sensing units 1240a-2 may generate a plurality of hit signals, respectively, that are distinguished from each other, and a plurality of second-second sensing units 1240b-2 may generate a plurality of hit signals, respectively, that are distinguished from each other. However, the present disclosure is not necessarily limited thereto, and the second-first sensing units 1240a-2 and the second-second sensing units 1240b-2 may all generate the same hit signal.

The second-second communication unit 1230-2 may transmit the hit signals generated by the sensing units 1240a-2 and 1240b-2 to the first receiving unit 131-1, for example, a first-second receiving unit 131b-1, of the control part 1300. The second-second communication unit 1230-2 provided in each of the second-first striking target 1200a-2 and the second-second striking target 1200b-2 may use the same or different types of transmission units.

Each of the above-described sensing units 1240a-1, 1240b-1, 1240a-2, and 1240b-2 may include a pressure sensor and/or an impact detection sensor, but is not necessarily limited to one type of sensor, and may be configured in a form in which sensors capable of detecting various types of hits are combined and employed to eliminate errors in detection of the hits and obtain information about various physical quantities that change according to the hit.

The striking object 1100-1 of the first player 1A1 may include the first-first striking object 1100a-1 and the first-second striking object 1100b-1. The striking object 1100-2 of the second player 1A2 may include the second-first striking object 1100a-2 and the second-second striking object 1100b-2. Only one striking object 100a-1, 100b-1, 100a-2, or 100b-2 is illustrated in FIG. 13, but one pair striking objects 100a-1, 100b-1, 100a-2, or 100b-2 may be provided on both hands and on both feet of each of the players 1A1 and 1A2.

The first-first striking object 1100a-1 and the first-second striking object 1100b-1 may include a first-first communication unit 1130a-1 and a first-second communication unit 1130b-1, respectively, and transmit position signals thereof. Similarly, the second-first striking object 1100a-2 and the second-second striking object 1100b-2 may include a first-third communication unit 1130a-2 and a first-fourth communication unit 1130b-2, respectively, and transmit position signals thereof.

The communication units 1130a-1, 1130b-1, 1130a-2, and 1130b-2 (i.e., 1130) may each be any type of communication unit as long as it can transmit a position signal, and as one example, may include a magnet or an RFID tag. The first-first communication unit 1130a-1 and the first-second communication unit 1130b-1 may transmit the same or different position signals. Similarly, the first-third communication unit 1130a-2 and the first-fourth communication unit 1130b-2 may transmit the same or different position signals.

The sensing units 1240a-1, 1240b-1, 1240a-2, and 1240b-2 (i.e., 1240) of the striking targets 1200 may be provided to detect the approach of the striking object 1100. At least one of the sensing units 1240 may be a magnetic field reader or an RFID reader. Accordingly, each of the striking targets 1200a-1, 1200b-1, 1200a-2, and 1200b-2 may detect a hit by distinguishing which striking object among the striking objects 1100a-1, 1100b-1, 1100a-2, and 1100b-2 strikes the hit.

In addition, the sensing units 1240, which have detected the hit of each striking object, may transmit a position signal corresponding to the hit, in which the striking object is identified, to the control part 1300, as an example, to a second receiving unit 131-2, through transmission units 1230-1 and 1230-2.

The second receiving unit 131-2 may receive the position signals from the striking targets 1200. The second receiving unit 131-2 may include a second-first receiving unit 131a-2 and a second-second receiving unit 131b-2. The second-first receiving unit 131a-2 may receive the position signals transmitted from the second-first transmission units 1230-1, and the second-second receiving unit 131b-2 may receive the position signals transmitted from the second-second transmission units 1230-2.

However, the present inventive is not limited thereto, and the second-first receiving unit 131a-2 may be provided to receive the position signals transmitted from the second-first communication unit 1230-1 of the first-first striking target 1200a-1 and the second-second communication unit 1230-2 of the second-first striking target 1200a-2, and the second-second receiving unit 131b-2 may be provided to receive the position signals transmitted from the second-first communication unit 1230-1 of the first-second striking target 1200b-1 and the second-second communication unit 1230-2 of the second-second striking target 1200b-2.

According to an embodiment, the second-first receiving unit 131a-2 and the second-second receiving unit 131b-2 may be provided as a single receiving unit, rather than being divided as shown in FIG. 13.

The control part 1300 may further include a signal processing unit 1310, an output value generation unit 1320, and an image signal generation unit 1330 in addition to the above-described receiving units 131.

The receiving units 131 are the same as described above in relation to the striking object 1100 and striking target 1200.

The signal processing unit 1310 may generate the third hit signal 1ST3 on the basis of the first hit signal 1ST1 and the second hit signal 1ST2. The first hit signal 1ST1 may include first information about a striking action, and the first information may be information that is extracted from the inertial signal 1S1 and the detection signal 1S2 by the hit determination device 110 included in the striking object 1100.

The output value generation unit 1320 may be electrically connected to the signal processing unit 1310 and may generate an output value corresponding to the third hit signal 1ST3. At this point, the output value may be generated by increasing or decreasing cumulatively according to the hit detected by each of the sensing units 1240.

The image signal generation unit 1330 may be electrically connected to the output value generation unit 1320 and may generate the image signal 1SM corresponding to the output value.

The display part 1500 may be electrically connected to the image signal generation unit 1330 and may display an image corresponding to the image signal 1SM.

More specifically, the output value generated by the output value generation unit 1320 may include a first output value corresponding to a third-first hit signal generated due to a striking action at a first time point, a second output value corresponding to a third-second hit signal generated due to a striking action at a second time point later than the first time point, and a third output value obtained by adding or subtracting the first output value and the second output value to or from the first output value. The third hit signal 1ST3 may be a concept including the third-first hit signal and the third-second hit signal.

Accordingly, the image signal 1SM may also include a first image signal corresponding to the first output value and a second image signal corresponding to the third output value.

The image displayed by the display part 1500 may include a first image corresponding to the first image signal and a second image corresponding to the second image signal.

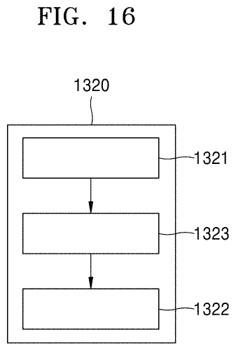

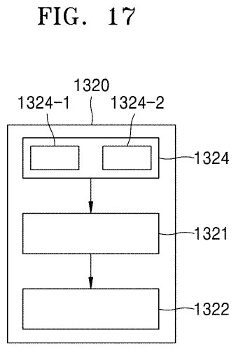

Other embodiments of the output value generation unit 1320 will be described in further detail with reference to FIGS. 16 and 17 to be described below.

FIG. 14 is a diagram schematically illustrating some components of the hit determination device 110 according to an embodiment of the present disclosure.

The IMU 110 may output the inertial signal 1S1 including three-dimensional information about a striking action. The IMU 1120 may include an interface 1121, a gyro sensor (gyroscope) 1122, an acceleration sensor (accelerometer) 1123, a magnetic field sensor (magnetometer) 1124, and a memory 1125.

The interface 1121 may serve to recognize pieces of information obtained by the sensors 1122, 1123, and 1124, perform signal processing, and transfer or transmit the signal-processed information to an external element such as the first communication unit 1130.

The IMU 1120 may include at least one of the gyroscope 1122, the accelerometer 1123, and the magnetometer 1124, or may be configured by combining multiple axes of each of the sensors 1122, 1123, and 1124. As an example, at least one of the gyroscope 1122, the accelerometer 1123, and the magnetometer 1124 may be a three-axis sensor.

The gyroscope 1122 may measure rotational inertia and/or rotation rate (an example of a unit is deg/sec) using an angular velocity of the striking object 1100, the accelerometer 1123 may measure movement inertia (an example of a unit is g (where 1 g=9.8 m/s²)) of the striking object 1100 using acceleration of the striking object 1100, and the magnetometer 1124 may measure an azimuth angle of the striking object 1100.

For example, a control unit (not shown) of the IMU 1120 may obtain posture information, which includes information about a roll angle, a pitch angle, and a yaw angle of the striking object 1100, speed information, and rotation information by respectively using the gyroscope 1122, the accelerometer 1123, and the magnetometer 1124. Thereafter, the control unit (not shown) of the IMU 1120 may generate the inertial signal 1S1 including information about the strength of the hit and the striking action of the striking object 1100 on the basis of the posture information, the speed information, and the rotation information.

The IMU 1120 may obtain information such as speed, direction, gravity, acceleration, or the like of the striking object 1100 using the sensors 1122, 1123, and 1124 to clearly identify the striking action. In other words, the IMU 1120 may generate the inertial signal 1S1 that includes information about the strength or various movements of the striking action of the striking object 1100 in three-dimensional directions including an X-axis, a Y-axis, and a Z-axis.

According to an embodiment, the information about the strength of the striking action may be calculated using a signal output by a separately provided strength measuring device (not shown), and may also be calculated using both the IMU 1120 described above and the strength measuring device.

The memory 1125 may perform a function of temporarily or permanently storing all types of data to be received or processed by all of the devices provided in the IMU 1120 such as the interface 1121 and the sensors 1122, 1123, and 1124. The memory 1125 is a computer-readable recording medium, and may include a RAM, a ROM, and a permanent mass storage device such as a disk drive. Alternatively, the memory 1125 may include a magnetic storage medium or a flash storage medium, but the scope of the present disclosure is not limited thereto.

The control part 1300 (see FIGS. 11 to 13) according to an embodiment may calculate the strength of the striking action on the basis of the inertial signal 1S1 and determine the form of the striking action. In the case of the combat match, scores given to various actions of the striking object 1100 may be different. Here, according to the IMU 1120 according to one embodiment, the type/form of the striking action may be determined and the strength of the hit may be calculated on the basis of the inertial signal 1S1, so that the striking action may be dearly identified. Thereafter, scoring the combat match may be performed through a method of applying a predetermined rule of the combat match to the strength of the hit and the striking form, determining a valid hit, and calculating a score. Here, when the information about the striking action, which is analyzed through the control part 1300, does not match the predetermined rule of the combat match, the hit may not be identified as a valid hit and may not be scored.

As described above, according to the combat sports system according to an embodiment of the present disclosure, accurate and precise scoring is possible by clearly identifying the striking action of the striking object 1100 through the IMU 1120.

The IMU 1120 may be provided at one end of the striking object 1100 to ensure free movement of the striking object 1100. As an example, the one end may be a wrist when the striking object 1100 is a hand, and may an ankle when the striking object 1100 is a foot. Alternatively, the IMU 1120 may be provided at one end of the striking object 1100 by being attached on a protector worn on the striking object 1100.

The sensors included in the IMU 1120 are not limited to the sensors described above, and may further include a pressure and/or impact detection sensor, or may be configured in a form of combining various types of sensors to obtain information about various physical quantities related to the striking action.

FIG. 15 is a diagram schematically illustrating a configuration of the approach detection device 1400 according to an embodiment of the present disclosure. In FIG. 15, a system including the striking objects 1100a-1 and 1100b-1 (i.e., 1100-1) of the first player 1A1 and the striking target 1200-2 of the second player 1A2 will be described as an example.

The striking object 1100-1 may include a first striking object 1100a-1 including a first detection antenna 1110a, and a second striking object 1100b-1 including a second detection antenna 1110b. The detection target 1220 is located on a scoring portion of the striking target 1200-2. The detection target 1220 may be a concept including different detection targets 1220 provided at different striking targets. In addition, a plurality of detection targets 1220 may be present on the scoring portion, but for convenience of description, one detection target 1220 is illustrated in FIG. 15.

The first detection antenna 1110a may transmit a first call signal 1CSa to activate the detection target 1220, and the second detection antenna 1110b may transmit a second call signal 1CSb to activate the detection target 1220. Here, the first call signal 1CSa and the second call signal 1CSb may be received by the same detection target 1220 or may be respectively received by different detection targets 1220.

The detection target 1220 may transmit a first response signal 1RSa including first identification information to the first detection antenna 1110a in response to the first call signal 1CSa, and may transmit a second response signal 1RSb including second identification information to the second detection antenna 1110b in response to the second call signal 1CSb. Similarly, the first response signal 1RSa and the second response signal 1RSb may be transmitted by the same detection target 1220 or may be respectively transmitted by different detection targets 1220.

The detection target 1220 may include a memory chip 1223 in which the identification information is stored and an antenna 1221 connected to the memory chip 1223. The memory chip 1223 may include identification information only for distinguishing the striking targets 1200, or may further include identification information for distinguishing the players 1A1 and 1A2 to which the detection targets 1220 are provided.

Thereafter, the first detection antenna 1110a may decode the first identification information on the basis of the first response signal 1RSa and output and transmit a first detection signal 1S2-a to the control part 1300. Similarly, the second detection antenna 1110b may decode the second identification information on the basis of the second response signal 1RSb and output and transmit a second detection signal 1S2-b to the control part 1300. Here, the response signals 1RSa and 1RSb may be transmitted to the control part 1300 through the first communication unit 1130.

The detection antennas 1110a and 1110b may recognize the response signals 1RSa and 1RSb, which are transmitted by the detection target 1220, through readers 1115a and 1115b. The readers 1115a and 1115b may decode the identification information stored by the memory chip 1223 of the detection target 1220 to generate the detection signal 1S2, and transmit the detection signal 1S2 to the control part 1300.

As an example, when the detection target 1220 is an RFID tag, the readers 1115a and 1115b may be RFID readers, and the detection antennas 1110a and 1110b may be RFID detection antennas. In this case, the response signals 1RSa and 1RSb may be RF signals. As another example, when the detection target 1220 is a magnet, the detection antennas 1110a and 1110b may be magnetic field detection antennas, and the response signals 1RSa and 1RSb may be magnetic field signals.

Thereafter, the control part 1300 may calculate a score by distinguishing the striking actions, which strike hits to different detection targets 1220, on the basis of the first detection signal 1S2-a and the second detection signal 1S2-b.

According to an embodiment, even when different striking objects 1100a-1 and 1100b-1 strike the detection target 1220 including the same identification information, the striking object 1100a-1 or 1100b-1 may convert the response signal 1RSa or 1RSb received through the detection antenna 1110a or 1110b to output the detection signal 1S2, through which the striking objects 1100a-1 and 1100b-1 may be identified, using a control unit (not shown) included in each of the striking objects 1100a-1 and 1100b-1. In this case, the control part 1300 may calculate the score by distinguishing the striking actions performed by different striking objects 1100a-1 and 1100b-1.

In a case in which the striking object 1100 includes the detection target 1220, and the striking target 1200 includes the detection antenna 1110, there may be a limitation in that it is difficult to determine all valid hits because it is difficult to detect a striking action performed by a part of the striking object 1100 in which the detection target 1220 is not provided. In addition, depending on the location of the striking target 1200 provided with the detection antenna 1110, there may be a blind spot in which the detection target 1220 is not recognized, and thus a problem that a hit is not recognized as a valid hit may also occur when the speed of the striking action of the striking object 1100 is high.

However, according to the combat sports system according to an embodiment of the present disclosure, entire valid hits for the scoring portions of the striking target 1200 may be accurately and uniformly determined by detecting the detection target 1220 of the striking target 1200 using the detection antenna 1110 provided to the striking object 1100. In addition, by providing the detection antenna 1110 to each of all the striking objects 1100, it is possible to determine whether the striking object 1100 is close to the striking target 1200, thereby minimizing errors in scoring the combat match.

FIG. 16 is a block diagram schematically illustrating the output value generation unit according to an embodiment of the present disclosure.

The output value generation unit 1320 of the control part 1300 may include a detection unit 1321, a calculation unit 1322, and a valid hit determination unit 1323.

The detection unit 1321 may sequentially detect a first output value and a second output value according to the third hit signal 1ST3 received from the signal processing unit 1310. The first output value may correspond to a third-first hit signal generated due to a striking action at a first time point, and the second output value may correspond to a third-second hit signal generated due to a striking action at a second time point later than the first time point.

The calculation unit 1322 may be electrically connected to the detection unit 1321. The calculation unit 1322 may calculate a difference value between the first output value and the second output value and then calculate a third output value obtained by adding or subtracting the difference value to or from the first output value.

The valid hit determination unit 1323 may be electrically connected to the detection unit 1321, and may determine whether the third hit signal 1ST3 is a hit signal generated due to a valid hit by applying a predetermined rule of the combat match. For example, the valid hit determination unit 1323 may operate in a manner of determining a hit as a valid hit when a proximity distance between the striking object 1100 and the striking target 1200, which is obtained from the detection signal 1S2 received through the detection antenna 1110, and/or a pressure detected by the sensing unit 1240 exceed a preset valid hit determination criterion.

The valid hit determination unit 1323 may determine whether the third hit signal 1ST3 is due to the valid hit in such a manner, and generate a control signal including the determination result and transmit the control signal to the calculation unit 1322. At this point, the valid hit determination unit 1323 may operate so as not to generate an output value when a hit is not the valid hit.

In the embodiment of FIG. 16, the valid hit determination unit 1323 is illustrated as being located between the detection unit 1321 and the calculation unit 1322, but the present disclosure is not limited thereto, and the valid hit determination unit 1323 may be electrically connected to at least one of the detection unit 1321 and the calculation unit 1322 regardless of an order. In addition, the valid hit determination unit 1323 is not necessarily included in the output value generation unit 1320 and may be installed in each of the striking targets 1200 (see FIG. 13). In this case, the valid hit determination unit 1323 may determine whether the corresponding hit signal is due to a valid hit or not, and transmit the corresponding control signal to the control part 1300 using the second communication units 1230-1 and 1230-2. This is equally applicable to all embodiments of the present disclosure to be described below.

FIG. 17 is a block diagram schematically illustrating an output value generation unit according to another embodiment of the present disclosure.

According to another embodiment, an output value generation unit 1320 may include a striking action determination unit 1324, and the striking action determination unit 1324 may include at least one of a striking object determination unit 1324-1 and a striking target determination unit 1324-2.

The striking object determination unit 1324-1 may distinguish the striking object 1100, which has generated a hit signal that caused the first hit signal 1ST1, on the basis of the position signals received from the above-described first communication units 1130a-1, 1130b-1, 1130a-2, and 1130b-2 (see FIG. 13).

The striking target determination unit 1324-2 may distinguish the striking target 1200, which has generated the hit signal that caused the first hit signal 1ST1, on the basis of the detection signals 1S2-a and 1S2-b respectively received through the detection antennas 1110a and 1110b (see FIG. 14), which are different, of the hit determination device 110.

In other words, when a description is made with reference to FIG. 13 together, the striking targets 1200a-1 and 1200b-1 of the first player 1A1 may include the first-first sensing units 1240a-1 provided at different positions and the first-second sensing units 1240b-1 provided at different positions, respectively, and the striking targets 1200a-2 and 1200b-2 of the second player 1A1 may include the second-first sensing units 1240a-2 provided at different positions and the second-second sensing units 1240b-2 provided at different positions, respectively. Here, the output value generation unit 1320 may operate to differently generate an output value, which corresponds to the second hit signal 1ST2 generated from the first-first and second-first sensing units 1240a-1 and 1240a-2 (hereinafter, collectively referred to as the first sensing unit 1240a), and an output value corresponding to the second hit signal 1ST2 generated from the first-second and second-second sensing units 1240b-1 and 1240b-2 (hereinafter, collectively referred to as the first sensing unit 1240b).

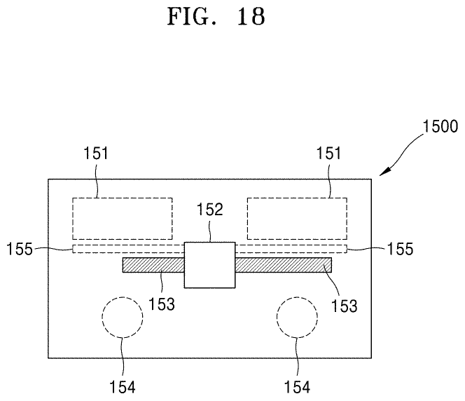

FIG. 18 is a diagram illustrating a configuration of a display image displayed by the display part 1500 according to an embodiment of the present disclosure.

The display image may include a player image 151 displaying a name, a picture, and/or the like of a player, a time image 152 displaying time information such as an elapsed time or a remaining time, and a progress image 153 intuitively displaying status information of the match. In addition to the above, the display image may further include a first additional image 154 displaying a strength of a delivered hit, a score due to the hit, a type of a striking technique (for example, a head kick, a body kick, a double kick, or a consecutive kick), and the like. In addition, the display image may further include a second additional image 155 displaying an additional time given due to a penalty.

The progress image 153 may be configured such that players playing the match, referees, and/or spectators can intuitively grasp match progress information, and for example, may be expressed as a bar graph. The above-described first and second images may correspond to the progress image 153. The second additional image 155 may represent a penalty time given to each of the players. The second additional image 155 may also be configured to intuitively provide time information, and may be expressed as a bar graph as an example.

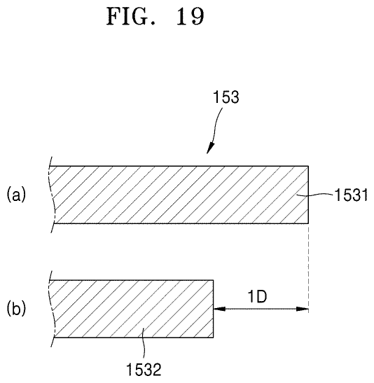

FIG. 19 is a diagram illustrating one example of the progress image 153 according to an embodiment of the present disclosure. When the output value generation unit 1320 generates a first output value in response to a third-first hit signal generated due to a striking action at a first time point, and accordingly, the image signal generation unit 1330 generates a first image signal corresponding to the first output value, a first image 1531 as shown in FIG. 19A may be displayed on the display part 1500 in response to the first image signal. The first image 1531 may be a bar graph, such as an energy bar, but is not limited thereto, and may have various forms in which a match status can be intuitively provided.

The output value generation unit 1320 may generate a second output value in response to a third-second hit signal generated due to a striking action at a second time point later than the first time point, and as described above, the output value generation unit 1320 may calculate a difference value between the first output value and the second output value, and then generate a third output value obtained by subtracting the difference value from the first output value. In addition, the image signal generation unit 1330 may generate a second image signal corresponding to the third output value at the second time point, and the display part 1500 may display a second image 1532 as shown in FIG. 19B in response to the second image signal.

That is, the first image 1531 shown in FIG. 19A may be an image corresponding to the first output value at the first time point, and the second image 1532 shown in FIG. 193 may be an image corresponding to the third output value obtained by subtracting the difference value from the first output value at the second time point. Thus, the second image 1532 may be an image in which the energy bar is reduced by a distance 1D corresponding to the difference value from the first image 1531.

This may intuitively show the progress or status of the match at the first time point and the second time point to the players, the referees, and/or the spectators, while the match is being carried out. As the match gradually progresses, the energy bar, which is the progress image 153, may be gradually reduced and may all disappear within a time limit, and thus information, indicating a player with no energy bar left may lose points or the match as a result, may be intuitively provided to the players, the referees, and/or the spectators.

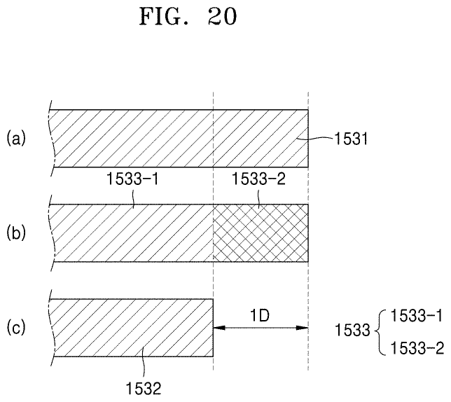

FIG. 20 is a diagram illustrating another example of the progress image 153 of FIG. 19. Features distinguished from FIG. 19 will be mainly described.

FIGS. 20A and 20C illustrate images corresponding to the first image 1531 and the second image 1532 of FIGS. 19A and 19B, respectively. Before the second image 1532 of FIG. 20C is generated at the second time point, a third image 1533 of FIG. 20B may be generated.

The third image 1533 may be an image in which an image corresponding to the distance 1D corresponding to the difference value is replaced with an image of a different type from the existing image in the first image 1531, after the first image 1531 is generated. In other words, the third image 1533 may include a first part 1533-1 and a second part 1533-2, and the second part 1533-2 may be distinguished from the first part 1533-1 by having a different color or tone from the first part 1533-1 constituting the existing first image 1531 and second image 1532. For example, the first part 1533-1 may be expressed in blue and the second part 1533-2 may be expressed in red.

Thereafter, finally, as shown in FIG. 20C, the second image 1532 obtained by deleting the second part 1533-2 from the third image 1533 at the second time point may be generated.

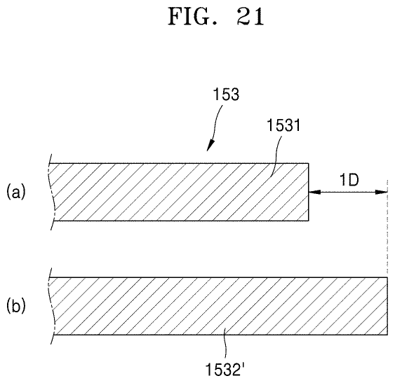

FIG. 21 is a diagram illustrating another example of the progress image 153 according to an embodiment of the present disclosure.

A first image 1531 shown in FIG. 21A may be an image corresponding to the first output value at the first time point, and a second image 1532′ shown in FIG. 21B may be an image corresponding to a third output value obtained by adding the difference value to the first output value at the second time point. Thus, the second image 1532′ may be an image in which the energy bar is increased by a distance 1D corresponding to the difference value from the first image 1531.

This may intuitively show the progress or status of the match at the first time point and the second time point to the players, the referees, and/or the spectators, while the match is being carried out. As the match gradually progresses, the energy bar, which is the progress image 153, may be gradually increased, and may be fully increased within a time limit, and thus information, indicating a player with the energy bar fully increased to the limit may lose points or the match, may be intuitively provided to the players, the referees and/or the spectators.

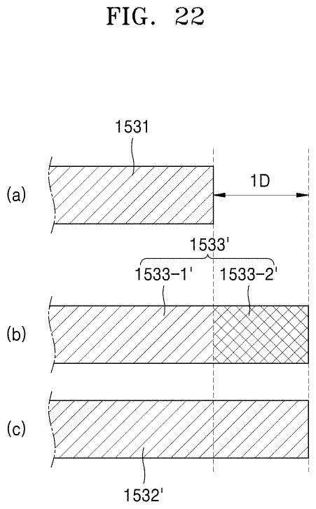

FIG. 22 is a diagram illustrating another example of the progress image of FIG. 21. Features distinguished from FIG. 21 will be mainly described.

FIGS. 22A and 20C illustrate images corresponding to the first image 1531 and the second image 1532′ of FIGS. 21A and 21B, respectively. Before the second image 1532′ of FIG. 22C is generated at the second time point, a third image 1533′ of FIG. 22B may be generated.

The third image 1533′ may be an image in which an image corresponding to a distance 1D corresponding to the difference value is replaced with an image of a different type from the existing image in the first image 1531, after the first image 1531 is generated. In other words, the third image 1533′ may include a first part 1533-1′ and a second part 1533-2′, and the second part 1533-2′ may be distinguished from the first part 1533-1′ by having a different color or tone from the first part 1533-1′ constituting the existing first image 1531 and second image 1532′. For example, the first part 1533-1′ may be expressed in blue and the second part 1533-2′ may be expressed in red.

Thereafter, finally, as shown in FIG. 22C, the second image 1532′ at the second time point may be generated.

The distance 1D corresponding to the difference value may be modified in various forms, and an image signal 153 may be generated accordingly.

As one example, by processing all hit signals due to hits delivered to the striking targets 1200a-1, 1200b-1, 1200a-2, and 1200b-2 to have the same value, an image signal may be generated such that the distance 1D corresponding to the difference value is proportional to the number of hits.

As another example, weights may be respectively applied to hit signals generated due to hits delivered to the striking targets 1200a-1, 1200b-1, 1200a-2, and 1200b-2, and the hit signals may be processed with different values for each weight. For example, a weight applied to a hit signal generated due to a hit delivered to the first-first striking target 1200a-1 and the second-first striking target 1200a-2, which are provided on the head, may be higher than a weight applied to a hit signal generated due to a hit delivered to the first-second striking target 1200b-1 and the second-second striking target 1200b-2 that are provided on the body.

Accordingly, an output value corresponding to the hit signal generated due to the hit delivered to the first-first striking target 1200a-1 and the second-first striking target 1200a-2 may be output to be greater than an output value corresponding to the hit signal generated due to the hit delivered to the first-second striking target 1200b-1 and the second-second striking target 1200b-2. Accordingly, the difference value corresponding to the hit signal generated due to the hit delivered to the first-first striking target 1200a-1 and the second-first striking target 1200a-2 may also be greater than the difference value corresponding to the hit signal generated due to the hit delivered to the first-second striking target 1200b-1 and the second-second striking target 1200b-2. Further, the image signal may be generated, such that, in the distance 1D corresponding to each difference value, the distance due to the hit delivered to the first-first striking target 1200a-1 and the second-first striking target 1200a-2 is greater than the distance due to the hit delivered to the first-second striking target 1200b-1 and the second-second striking target 1200b-2.

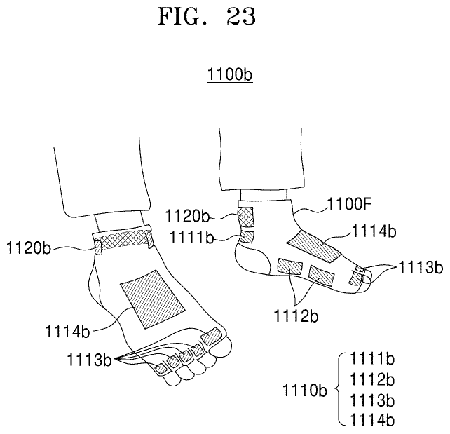

FIG. 23 is a view illustrating the hit determination device 110 according to an embodiment of the present disclosure. Hereinafter, descriptions of content that are the same as those described above will be briefly given or omitted and will be given with reference to FIGS. 11 to 15 together.

In FIG. 23, a second striking object 1100b is illustrated, and the second striking object 1100b may be a concept including the first-second and second-second striking objects 1100b-1 and 1100b-2 of the players 1A1 and 1A2. Hereinafter, a case in which the second striking object 1100b is a foot will be described as an example.

A second protector 1100F may be worn on the second striking object 1100b. An IMU 1120b and a detection antenna 1110b may be provided in a form of being embedded in or attached to the second protector 1100F.

The IMU 1120b may be provided on an ankle to ensure free movement of the foot. The detection antenna 1110b may also be provided at a part of the second striking object 1100b, to which the detection target 1220 is difficult to be attached in the past, so that all scoring portions of the striking target 1200 may be constantly and uniformly detected. For example, detection antennas 1111b, 1112b, and 1113b may be provided not only on an instep (1114b), but also on at least one part selected from among a heel (1111b), a side of the foot (1112b), and a toe (1113b), and may also be provided on other parts of the foot. Accordingly, it is possible to minimize the omission of valid hits in the combat match, so that accurate scoring is possible.

According to another embodiment, the detection antennas 1110b may also be provided integrally on the entire foot, mainly on the instep (1114a), without being separately provided for each part as described above, thereby identifying the striking object 1100b in which the detection antennas 1110b are provided.

As an example, the detection antennas 1111b, 1112b, 1113b, and 1114b (i.e., 1110b) shown in FIG. 23 may be provided in a form of an antenna forming a closed curved line like the detection antenna 1110b shown in FIG. 15.

Although not shown in the drawing, the second striking object 1100b may include at least one first communication unit 1130b-1. The first communication unit 1130b-1 may be a communication unit that transmits a hit signal generated due to a striking action of the second striking object 1100b using a wireless communication method, and may include different types of communication units, and as an example, may also be provided in a form of a magnet or an RFID tag.

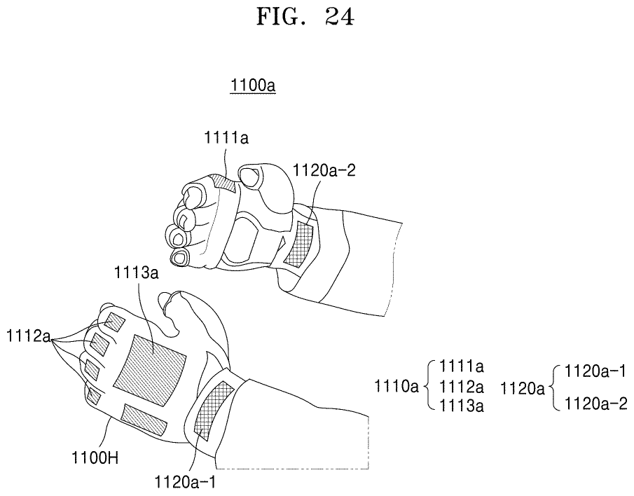

FIG. 24 is a view illustrating a hit determination device according to another embodiment of the present disclosure.

In FIG. 24, a first striking object 1100a is illustrated, and the first striking object 1100a may be a concept including the first-first and second-first striking objects 1100a-1 and 1100a-2 of the players 1A1 and 1A2. Hereinafter, a case in which the first striking object 1100a is a hand will be described as an example.

A first protector 1100H may be worn on the first striking object 1100a. An IMU 1120a and a detection antenna 1110a may be provided in a form of being embedded in or attached to the first protector 1100H.

The IMU 1120a may be provided on a wrist to ensure free movement of the hand. In more detail, the IMU 1120a may be provided on an outer part (1120a-1) of the wrist or may be provided on an inner part (1120a-2) of the wrist.

The detection antenna 1110a may also be provided at a part of the first striking object 1100a, to which the detection target 1220 is difficult to be attached in the past, so that all scoring portions of the striking target 1200 may be constantly and uniformly detected. For example, detection antennas 1111a and 1112a may be provided not only on a back of the hand (1113a), but also on at least one part selected from fingers (1112a) and a side of the hand (1111a), and may also be provided on other parts of the hand.

According to another embodiment, the detection antennas 1110a may be provided integrally on the entire hand, mainly on the back of the hand (1113a), without being separately provided for each part as described above, thereby identifying the striking object 1100a in which the detection antennas 1110a are provided.

In addition, as an example, the detection antennas 1111a, 1112a, and 1113b (i.e., 1110a) shown in FIG. 24 may be provided in a form of an antenna forming a closed curved line like the detection antenna 1110a shown in FIG. 15.

Although not shown in the drawing, the first striking object 1100a may include at least one first communication unit 1130a-1. The first communication unit 1130a-1 may be a communication unit that transmits a hit signal generated due to a striking action of the first communication unit 1130a-1 using a wireless communication method, and may include different types of communication units, and as an example, may also be provided in a form of a magnet or an RFID tag.

As an example, in FIGS. 23 and 24, the IMUS 1120a and 1120b may be provided using an impact mitigating material to improve durability, so that the strength of a hit or the like may be accurately detected. Further, as an example, the detection antennas 1110a and 1110b may be designed to use a conductive fabric.

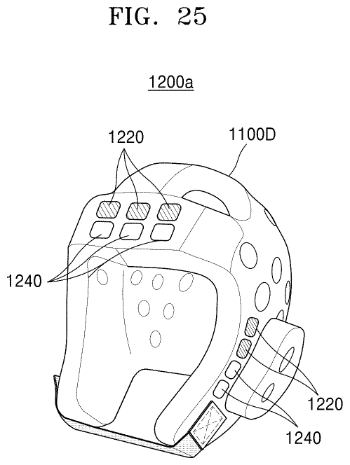

FIG. 25 is a view illustrating a striking target according to an embodiment of the present disclosure. In FIG. 25, a first striking target 1200a is illustrated, and the first striking target 1200a may be a concept including the first-first and second-first striking targets 1200a-1 and 1200a-2 of the players 1A1 and 1A2. Hereinafter, a case in which the first striking target 1200a is a head will be described as an example.

A third protector 11000 may be worn on the first striking target 1200a. The detection target 1220 and/or the sensing unit 1240 may be provided in a form of being embedded in or attached to the third protector 11000.

The detection antenna 1110 provided in the striking object 1100 may detect whether the detection target 1220 is in proximity using a magnetic field or an RF communication method even when the detection target 1220 is spaced apart from the detection antenna 1110 by a certain distance. According to an embodiment of the present disclosure, the detection target 1220 is provided around a part P of the striking target 1200, which is a part where it is difficult to directly detect a valid hit such as a front surface of the face, so that the valid hit may be determined even in the part P. As an example, a separation distance at which the detection antenna 1110 may detect the detection target 1220 may be about 15 cm or less, and specifically, about 10 cm or less.

As described above, at least one sensing unit 1240 may be provided in a scoring portion of the striking target 1200 and may detect a hit delivered to the corresponding striking target 1200, thereby generating the second hit signal 1ST2.

Hereinafter, a combat sports scoring system using augmented reality (AR) (hereinafter, simply referred to as a “combat sports scoring system” and described) will be described. Hereinafter, descriptions of content overlapping with those described above will be omitted or briefly given.

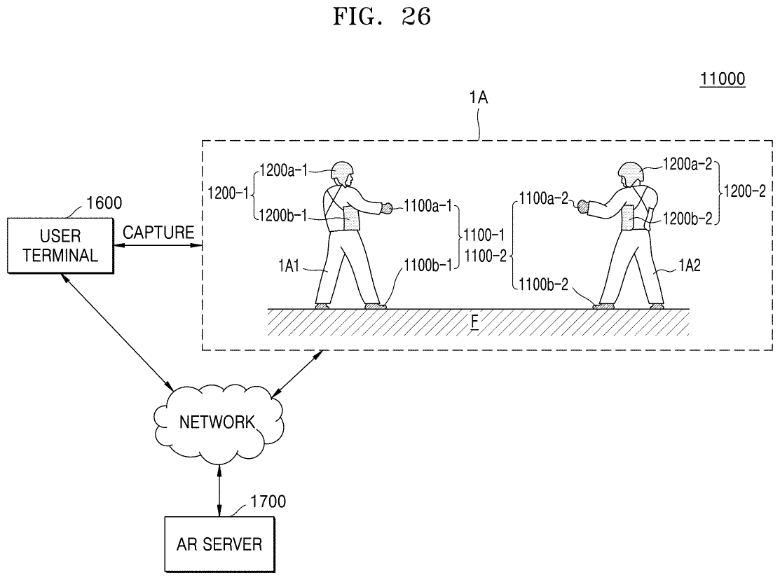

FIG. 26 is a view schematically illustrating a combat sports scoring system according to an embodiment of the present disclosure.

A combat sports scoring system 11000 includes a sparring object 1A that play a combat match, a user terminal 1600, and an AR server 1700, and the sparring object 1A, the user terminal 1600, and the AR server 1700 may communicate with each other through a network 1800. The user terminal 1600 may include an image capturing unit and/or a display unit, and may be a component corresponding to the display part 1500 described above. The content described with respect to the display part 1500 may be applied to the user terminal 1600. The AR server 1700 may be a component corresponding to the control part 1300 described above, and the content described with respect to the control part 1300 may be applied to the AR server 1700.

As described above, the sparring object 1A may include a first player 1A1 and a second player 1A2 facing each other on a floor F to play a match. Each of the players 1A1 and 1A2 may include striking objects 1100-1 and 1100-2 (i.e., 1100) that strike a hit, and striking targets 1200-1 and 1200-2 (i.e., 1200) to which the hit is delivered.

Here, referring to FIG. 12 again, the striking object 1100 may include the above-described hit determination device 110. However, according to an embodiment, at least one of the striking object 1100 and the striking target 1200 may include the hit determination device 110. The hit determination device 110 may include an IMU 1120, a detection antenna 1110, and a first communication unit 1130. The IMU 1120 may output an inertial signal including 3D information about a striking action of the striking object 1100. The hit determination device 110 may output different inertial signals 1S1 according to various striking actions, and the content described in the above-described embodiments may be equally applied to the hit determination device 110.

Meanwhile, the striking target 1200 may include a detection target 1220, which is detected by the detection antenna 1110. According to an embodiment, when the striking target 1200 includes the detection antenna 1110, the striking object 1100 may include the detection target 1220. Here, referring to FIG. 15 together, detection signals 1S2-a and 1S2-b (i.e., 1S2), through which the striking object 1100 and/or the striking target 1200 may be identified, may be generated by an approach detection device 1400 (1110 and 1220) provided in the striking object 1100 and the striking target 1200. The striking object 1100 may generate a first hit signal 1ST1 on the basis of an inertial signal 1S1 and a detection signal 1S2, and the striking target 1200 may generate a second hit signal 1ST2.

At least one of the striking object 1100 and the striking target 1200 may store marker information required for generating an AR scoring image. In the following description, the marker information may include information used for identifying an object in which the marker information is stored/included.

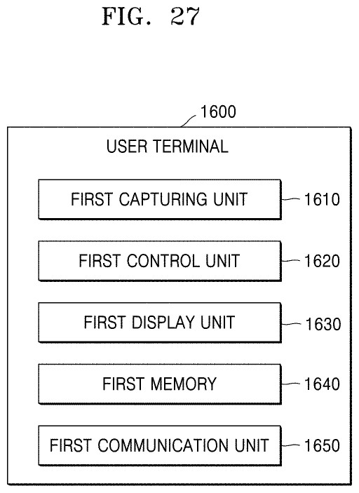

The user terminal 1600 may capture a state of the sparring object 1A in the match and generate a scoring target image for AR scoring on the basis of the captured image. The user terminal 1600 may recognize the marker information stored in the striking object 1100 and the striking target 1200 in generating the scoring target image. One user terminal 1600 is illustrated in FIG. 26, but the present disclosure is not limited thereto. At least two or more user terminals 1600 may be provided, and some thereof may capture an image of the sparring object 1A and the remainder may display and reproduce the scoring image. The user terminal 1600 will be described in more detail with reference to FIG. 27 to be described below.

The user terminal 1600 may be any one selected from a group consisting of a mobile device such as a smartphone, a smart television (TV), a tablet personnel computer (PC), a notebook computer, a desktop computer, a personal digital assistant (PDA), a portable multimedia player (PMP), and an electronic board, and when a plurality of user terminals 1600 are provided, devices of the same or different types may be selected from the group as the user terminals 1600. The type of the user terminal 1600 is not limited to the above-described devices, and any type may be possible as long as it performs functions of the image capturing unit and the display unit.

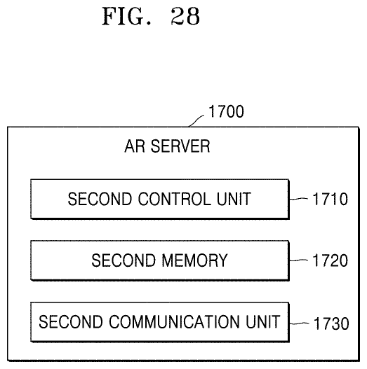

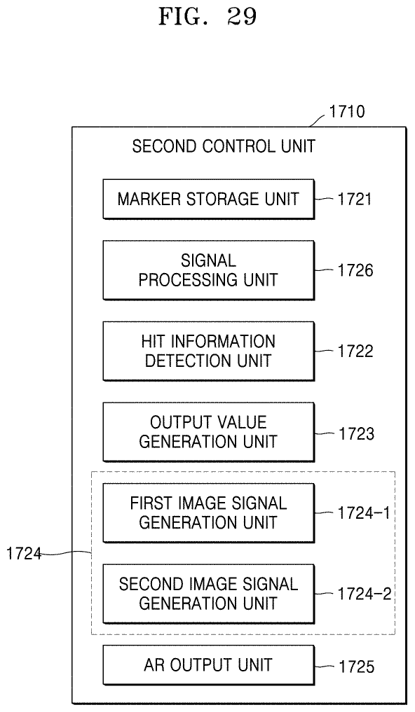

The AR server 1700 may receive the scoring target image from the user terminal 1600 and detect hit information of the sparring object 1A on the basis of the marker information. Thereafter, the AR server 1700 may generate a scoring image by synthesizing an image signal generated by itself with the scoring target image. The AR server 1700 will be described in more detail with reference to FIGS. 28 and 29 to be described below. The AR server 1700 is illustrated in FIG. 26 as being a separate component from the user terminal 1600, but according to an embodiment, the AR server 1700 may be provided in the user terminal 1600.

FIG. 27 is a block diagram schematically illustrating a configuration of the user terminal 1600 according to an embodiment of the present disclosure.

The user terminal 1600 may include a first capturing unit 1610, a first control unit 1620, a first display unit 1630, a first memory 1640, and a first communication unit 1650.

The first capturing unit 1610 may capture a state of the sparring object 1A in the combat match. As an example, the first capturing unit 1610 may be a camera, but the present disclosure is not limited thereto.

The first control unit 1620 may include a marker recognition unit and an image generation unit. The marker recognition unit may recognize the marker information, and the image generation unit may generate a scoring target image obtained by capturing the state of the sparring object 1A in the match. In the embodiment of FIG. 27, the first control unit 1620 and the first capturing unit 1610 are illustrated as being separate components, but the first control unit 1620 may be a component integrated with the first capturing unit 1610.

The first display unit 1630 may receive and display the scoring image generated from the AR server 1700, which will be described later. The first capturing unit 1610 and the first display unit 1630 are illustrated 1600 in the embodiment described with reference to FIG. 27 as being included in one user terminal, but according to an embodiment, the first capturing unit 1610 and the first display unit 1630 may be implemented on different user terminals 1600.

The first memory 1640 may temporarily and/or permanently store all data generated and/or processed in the user terminal 1600, such as the marker information provided by the sparring object 1A, an original image captured by the first capturing unit 1610, and the like.

The first communication unit 1650 may communicate with the sparring object 1A and the AR server 1700 through the network 1800, and the first communication unit 1650, the sparring object 1A, and the AR server 1700 may exchange pieces of data stored and/or generated by each other.

FIG. 28 is a block diagram schematically illustrating a configuration of the AR server 1700 according to an embodiment of the present disclosure.

The AR server 1700 may include a second control unit 1710, a second memory 1720, and a second communication unit 1730.

The second control unit 1710 controls overall operations of the AR server 1700, and will be described in more detail with reference to FIG. 29 to be described below.

The second memory 1720 may temporarily and/or permanently store all data generated and/or processed in the AR server 1700.

The second communication unit 1730 may communicate with the sparring object 1A and the user terminal 1600 through the network 1800, and the second communication unit 1730, the sparring object 1A, and the user terminal 1600 may exchange pieces of data stored and/or generated by each other.

FIG. 29 is a block diagram illustrating a configuration of the second control unit 1710, which is a control unit of the AR server 1700 according to an embodiment of the present disclosure, in more detail.

The second control unit 1710 may include a marker storage unit 1721, a signal processing unit 1726, a hit information detection unit 1722, an output value generation unit 1723, an image signal generation unit 1724, and an AR output unit 1725.

The marker storage unit 1721 may store marker information identical to marker information provided by the striking object 1100 and/or the striking target 1200 of the sparring object 1A to identify the marker information provided by the striking object 1100 and/or the striking target 1200 of the sparring object 1A. The marker storage unit 1721 may be provided in the second memory 1720, which is a memory of the AR server 1700.

The signal processing unit 1726 may generate a third hit signal 1ST3 on the basis of first and second hit signals 1ST1 and 1ST2 obtained from the sparring object 1A. The content described with respect to the above-described signal processing unit 1310 (see FIG. 13) may be equally applied to the signal processing unit 1726.

The hit information detection unit 1722 may detect hit information about the striking action on the basis of the marker information, the first hit signal 1ST1, the second hit signal 1ST2, and/or the third hit signal 1ST3. The hit information may include information about a strength of a hit, a type (form) of the striking action, a speed, a rotational speed, the striking object 1100 and/or the striking target 1200, in which the hit is involved, a hit portion, whether the strength of the hit exceeds a minimum strength to be determined as a valid hit, and the like.

The output value generation unit 1723 may generate an output value corresponding to the third hit signal. More specifically, the output value generation unit 1723 may output a first output value at a first time point, a second output value at a second time point later than the first time point, and a third output value obtained by subtracting a difference value between the first output value and the second output value from the first output value, on the basis of the hit information. The content described with respect to the above-described output value generation unit 1320 (see FIG. 13) may be equally applied to the output value generation unit 1723.

The image signal generation unit 1724 may generate an image signal to be synthesized with the scoring target image received from the user terminal 1600. The image signal generation unit 1724 may include a first image signal generation unit 1724-1 and a second image signal generation unit 1724-2.

The content described with respect to the above-described image signal generation unit 1330 (see FIG. 13) may be equally applied to the first image signal generation unit 1724-1. In other words, a progress image signal (may be a concept including the first image signal and the second image signal described above with reference to FIGS. 11 to 22) generated by the first image signal generation unit 1724-1 becomes a basis of a progress image 163 to be described below, and the progress image 163 may be expressed in a form of a bar graph or an energy bar to intuitively provide match status information. The progress image 163 may correspond to the above-described progress image 153 (see FIGS. 18 to 22).

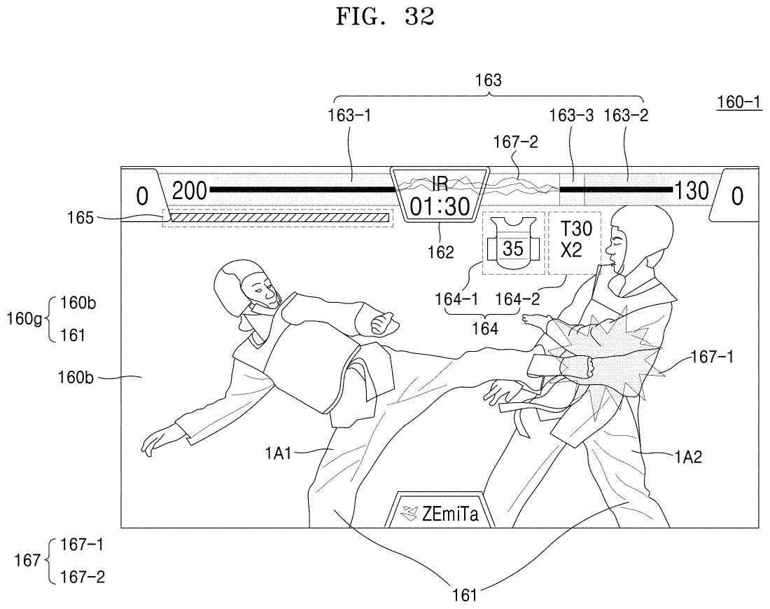

The second image signal generation unit 1724-2 may generate an effect image signal. The second image signal may be a basis of an effect image 167, which will be described later. The effect image 167 may be an image to visually represent whether a striking action is performed, whether a change has occurred, and changes in other images. The effect image signal may include information about whether a striking action is performed, a hit portion, or the like. As an example, the effect image 167 may be expressed as a visual effect through which the fact that the striking action was performed on a position corresponding to the hit portion of the striking target 1200, which is struck by the striking object 1100, may be visually recognized. The effect image 167 will be described further in example images illustrated in FIGS. 32, 33, 36, and 37, which will be described below.

The content described with respect to the user terminal 1600 and the AR server 1700 in FIGS. 27 to 29 may be equally applied to the following descriptions.

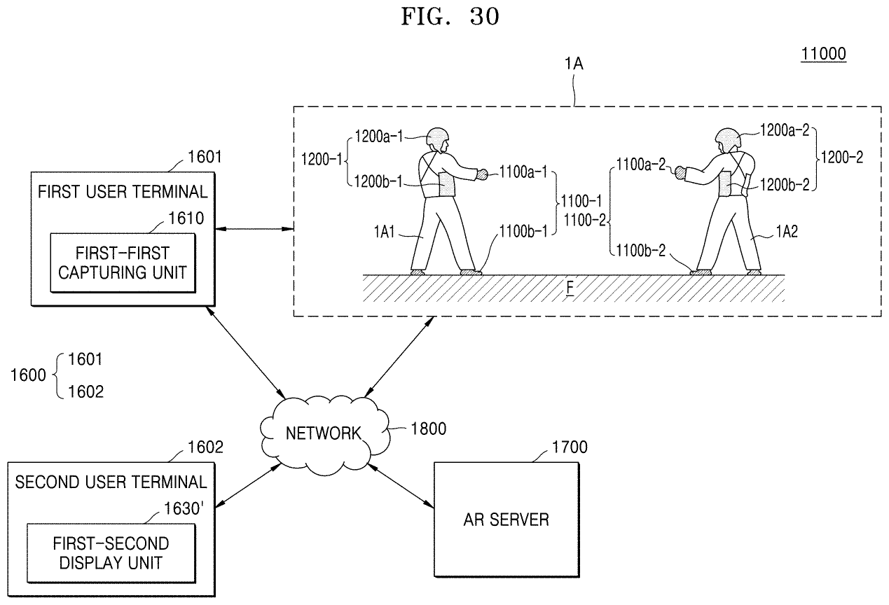

FIG. 30 is a view schematically illustrating a combat sports scoring system according to another embodiment of the present disclosure. The descriptions of the content overlapping those described above with reference to FIG. 26 will be omitted, and a description will be made focusing on features distinguished from those in FIG. 26.

A combat sports scoring system 11000 according to the embodiment of FIG. 30 may include a first user terminal 1601 and a second user terminal 1602. In this case, the first user terminal 1601 includes a first-first capturing unit 1610, and may generate a scoring target image by capturing a state of the sparring object 1A in the match using the first-first capturing unit 1610 and transmit the scoring target image to the AR server 1700. The second user terminal 1602 includes a first-second display unit 1630′, and may display and/or reproduce a scoring image, which is finally generated by synthesizing an image signal generated by the AR server 1700 with the scoring target image, through the first-second display unit 1630′.

As described above, the AR scoring image may be displayed through the user terminal 1600 (the first user terminal 1601 or the second user terminal 1602) by which an image of the sparring object 1A is captured, and in an embodiment, the AR scoring image may be displayed through a third user terminal (not shown) different from the user terminal 1600 by which an image of the sparring object 1A is captured. In other words, the display unit on which the AR scoring image is displayed may be provided in the same terminal including the capturing unit, or may be provided in a terminal different from the terminal including the capturing unit.

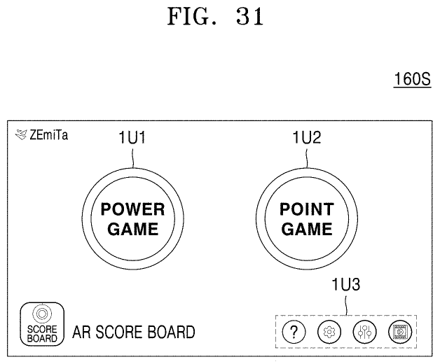

FIG. 31 is an exemplary view illustrating a start screen 160s of an output image of the combat sports scoring system according to an embodiment of the present disclosure. The start screen 160s may be displayed through the display unit 1630 of the user terminal 1600.

User interfaces (UIs) 1U1, 1U2, and 1U3 may be displayed on the start screen 160s. The UIs may include a first UI 1U1, a second UI 1U2, and a third UI 1U3.

The first UI 1U1 and the second UI 1U2 may be UIs for selecting modes of the AR scoring image. For example, the first UI 1U1 may be a UI to be selected so that a scoring method works in a power mode, and the second UI 1U2 may be a UI to be selected so that the scoring method works in a point mode. The power mode may be a mode operating to reduce or add an opponents energy by as much as the magnitude of the hit strength recognized by the hit determination device 110, and the point mode may be a mode operating to increase or decrease a score by as much as a score, which is assigned to the striking action, according to a preset match rule,

FIG. 31 illustrates only two first UI 1U1 and second UI 1U2 that operate in different modes, but in addition to this, other UIs that can be selected to operate in various modes may be further included.

The third UI 1U3 may include sub-UIs that perform various functions. For example, each of the sub-UIs may be selected so that any one function selected from a manual view, a device manager, an environment setting, and a scoring image view operates.

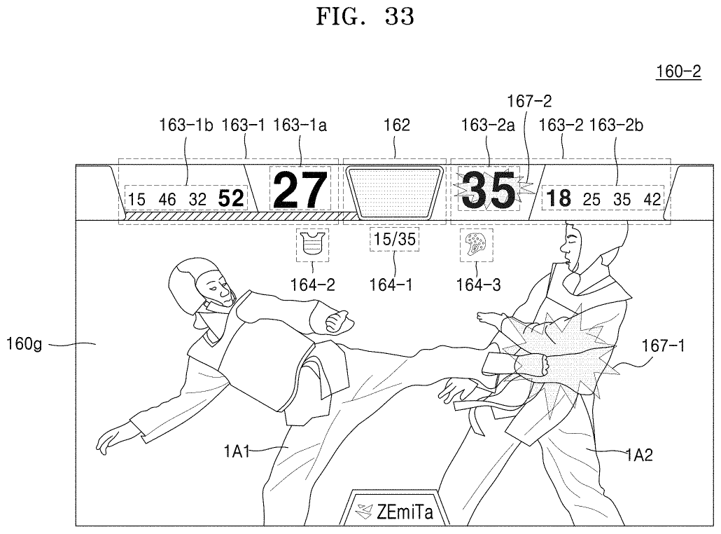

FIGS. 32 and 33 are exemplary views each illustrating an output image of the combat sports scoring system according to an embodiment of the present disclosure.

FIG. 32 is an exemplary view of an output image 160-1, at one time point, of the AR scoring image operating in a first mode. The first mode will be described by taking the power mode described above as an example.

The output image 160-1 in the first mode may include a scoring target image 160g, a time image 162, a progress image 163, a first additional image 164, a second additional image 165, and an effect image 167.

The scoring target image 160g may be an image captured using the image capturing unit 1610 of the user terminal 1600, and may include a background image 160b and a player image 161.

The descriptions of the player image 151, the time image 152, the progress image 153, the first additional image 154, and the second additional image 155 illustrated in FIG. 18 may be equally applied to the player image 161, the time image 162, the progress image 163, the first additional image 164, and the second additional image 165, respectively.

The progress image 163 is an image generated based on an progress image signal, which is generated by the first image signal generation unit 1724-1, and may include a first progress image 163-1, a second progress image 163-2, and a third progress image 163-3.

Specifically, the signal processing unit 1726 of the AR server 1700 may generate a third hit signal 1ST3 on the basis of a first hit signal 1ST1 generated by the striking object 1100 and a second hit signal 1ST2 generated by the striking target 1200. The output value generation unit 1723 may generate an output value corresponding to the third hit signal 1ST3, and the first image signal generation unit 1724-1 may generate the progress image signal corresponding to the output value.

The output value may include a first output value corresponding to a third-first hit signal generated due to a striking action at a first time point, a second output value corresponding to a third-second hit signal generated due to an striking action at a second time point later than the first time point, and a third output value obtained by adding or subtracting a difference value between the first output value and the second output value to or from the first output value. The progress image signal may include a first progress image signal corresponding to the first output value and a second progress image signal corresponding to the third output value. The first progress image 163-1 at the first time point may be displayed in response to the first progress image signal, and the first progress image 163-1 at the second time point be displayed in response to the second progress image signal. The first progress image 163-1 at the first time point may correspond to the first image 1531 described above with reference to FIGS. 18 to 22, and the first progress image 163-1 at the second time point may correspond to the second image 1532 or 1532′.

The content described with respect to the first progress image 163-1 may be equally applied to the second progress image 163-2.

The first progress image 163-1 and the second progress image 163-2 may respectively represent score states of the first player 1A1 and the second player 1A2. The two progress images 163-1 and 163-2 may be expressed by different colors, tones, or the like so as to identify the respective players 1A1 and 1A2.

The third progress image 163-3 may be an image of a part of each of the first progress image 163-1 and the second progress image 163-2, which is changed due to a hit of an opponent player. The third progress image 163-3 may correspond to the second part 1533-2 or 1533-2′ described above with reference to FIGS. 20 and 22.

A first-first additional image 164-1 may express a hit portion, which has caused the change, on a player side that caused the change in the progress image 163, and also express a change amount. A first-second additional image 164-2 may represent a penalty addition for a successful hit during a penalty time expressed by the second additional image 165. For example, the expression of “X2” indicates that the progress image 163 has been reduced by twice the amount of the original variation.

The effect image 167 is an image generated based on the second image signal generated by the second image signal generation unit 1724-2, and may be an image and/or a video that visually express a striking action. The effect image 167 expresses the visual effect described above, and may have a brightness higher than that of the overall scoring target image. The effect image 167 may be implemented in a form of lightning or flashing, but is not limited thereto, and may also be expressed in various forms that can be visually recognized that a hit is delivered.

As an example, in the effect image 167, an effect in a case in which a striking action is valid and an effect in a case in which the striking action is not valid may have different colors, forms, brightness, and the like. For example, the effect in the case in which the striking action is valid may be expressed in blue, and the effect in the case in which the striking action is not valid may be expressed in achromatic color. According to an embodiment, the effect image 167 may be different for each of the striking object 1100 and the striking target 1200 in which the striking action is performed.

An effect 167-1 may be an effect that is generated at a position corresponding to a hit portion to which a hit is delivered, and an effect 167-2 may be an effect that is simultaneously displayed when the progress image 163 is changed, that is, when the third progress image 163-3 is generated.

FIG. 33 is an exemplary view of an output image 160-2, at one time point, of the AR scoring image operating in a second mode. The second mode will be described by taking the point mode described above as an example. Descriptions of content overlapping with those described with reference to FIG. 32 will be omitted.

The output image 160-2 in the second mode may include a scoring target image 160g, a time image 162, a progress image 163, a first additional image 164, a second additional image 165, and an effect image 167.

The progress image 163 in the second mode may be expressed in a form of a score, rather than a bar graph, unlike in the first mode. A first progress image 163-1 may represent a score of any one of the first player 1A1 and the second player 1A2, and a second progress image 163-2 may express a score of a opponent player, which is another one of the first player 1A1 and the second player 1A2. Hereinafter, a case in which the first progress image 163-1 represents a score of the first player 1A1 and the second progress image 163-2 represents a score of the second player 1A2 will be described by way of example.

A first progress image 163-la may represent a point of the first player 1A1, and a first progress image 163-1b may represent hit strengths of last four attacks of the first player 1A1, and a strength value located closest to the first progress image 163-la may represent the most recent attack. Similarly, a second progress image 163-2a may represent a point of the second player 1A2, and a second progress image 163-2b may represent hit strengths of last four attacks of the second player 1A2, and a strength value located closest to the second progress image 163-2a may represent the most recent attack.

A first additional image 164-1 may represent a minimum hit strength for a score, and left and right sides of the first additional image 164-1 may respectively represent minimum hit strengths for the striking object 1100 and the striking target 1200 of the opponent players. For example, “15” on the left side may be a minimum scoring strength for a head, and “35” on the right side may be a minimum scoring strength for a body. The first additional images 164-2 and 64-3 may express hit portions that recently scored.

An effect 167-1 may be an effect on the hit portion, and an effect 167-2 may be an effect that is displayed on the progress images 163-la and 163-2a representing current scores.

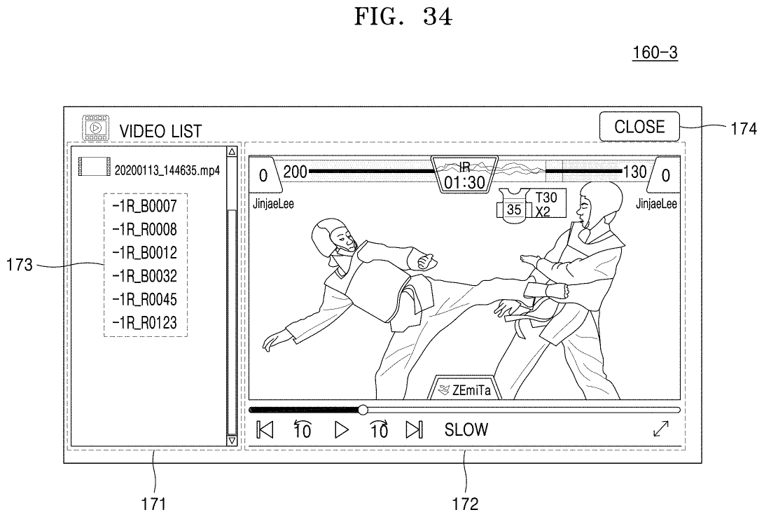

FIG. 34 is an exemplary view illustrating a screen for controlling an output image of the combat sports scoring system according to an embodiment of the present disclosure.

A control screen 160-3 may include a storage list 171, a player 172, a bookmark 173, and a movement UI 174.

The storage list 171 displays a list of scoring images finally generated by the AR server 1700. The player 172 is a part in which the scoring image is reproduced. The bookmark 173 expresses scores generated for each round (e.g., 1R), and when each bookmark is clicked, the bookmark 173 may move to a corresponding part of the scoring image and the corresponding part of the scoring image may be reproduced. The movement UI 174 is a UI that operates to move to a previous screen. In addition, the control screen 160-3 may include various UIs.

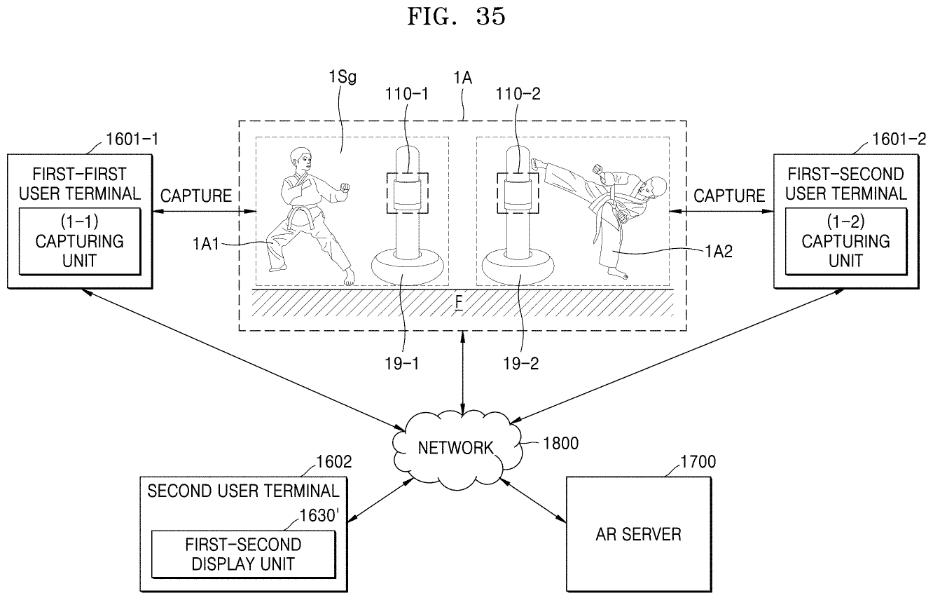

FIG. 35 is a view schematically illustrating a combat sports scoring system according to another embodiment of the present disclosure. Hereinafter, description of the same content as described above may be briefly given or omitted.

A combat sports scoring system 11000 may include a sparring object 1A, user terminals 1601-1, 1601-2, and 1602, and an AR server 1700.

First, an embodiment in which a sparring object 1A includes only a first player 1A1 and a first punching stand 19-1 will be described. The first player 1A1 may compete with the first punching stand 19-1 with a green screen 1Sg in which a background image of a scoring image is synthesized in the background. The marker information may include first marker information, and a first hit determination device 110-1 including the first marker information may be installed on the first punching stand 19-1. Here, the first player 1A1 may include or not include a hit determination device 110.

A first user terminal 1601-1 may include a first-first capturing unit 1610-1 configured to capture an image of a first sparring object, and a first control unit 1620 (see FIG. 27) configured to generate a scoring target image using an image captured by the first-first capturing unit 1610-1.

The second user terminal 1602 may include a second display unit 1630′, and the second display unit 1630′ may display the scoring image. The display unit is illustrated in FIG. 35 as being implemented in the second user terminal 1602, but the display unit may also be implemented in the first-first user terminal 1601-1, a first-second user terminal 1601-2, the second user terminal 1602, or another user terminal not shown in the drawing.

The AR server 1700 may generate an image signal, and synthesize the image signal to the scoring target image to generate a scoring image.

The AR server 1700 may generate a virtual striking object at a position corresponding to the first punching stand 19-1 to generate the scoring image.

Next, an embodiment in which the sparring object 1A further includes a second punching stand 19-2 and a second player 1A2 in addition to the first player 1A1 and the first punching stand 19-1 will be described. The second player 1A2 may also compete with the second punching stand 19-2 with the green screen 1Sg in which the background image of the scoring image is synthesized in the background. The marker information may include second marker information, and a second hit determination device 110-2 including the second marker information may be installed on the second punching stand 19-2. Here, the second player 1A2 may include or not include a hit determination device 110.

The second user terminal 1601-2 may include a first-second capturing unit 1610-2 configured to capture a second sparring object, and the first control unit 1620 (see FIG. 27) configured to generate a scoring target image using an image captured by the first-second capturing unit 1610-2.

The AR server 1700 may generate a scoring image on the basis of the first coring target image and the second scoring target image.

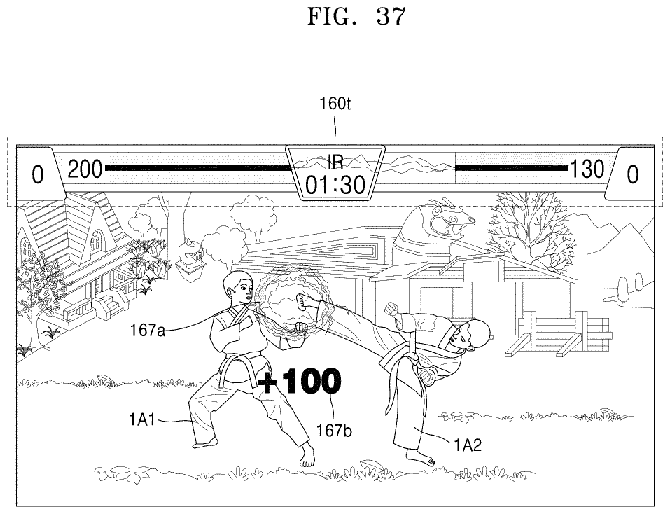

The AR server 1700 may generate a scoring image by closely moving captured images of the two players 1A1 and 1A2 and recombining the images. The scoring image may be implemented as an actual competition image. As an example, the AR server 1700 may generate a scoring image by outputting a second player image, which is an image of the second player 1A2, at a position corresponding to the first punching stand 19-1 of the first scoring target image and outputting a first player image, which is an image of the first player 1A1, at a position corresponding to the second punching stand 19-2 of the second scoring target image. The scoring image output according to the embodiment of FIG. 35 will be described in more detail with reference to FIG. 37 to be described below.

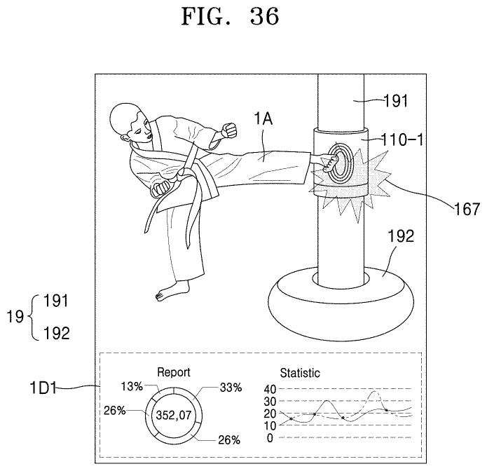

FIG. 36 is an exemplary view an output screen of the combat sports scoring system according to an embodiment of the present disclosure.

FIG. 36 is an exemplary view of an output screen of a measurement mode for measuring hit information of one player. A punching stand 19 may include a standing unit 191 and a support 192. A hit determination device 110-1 may be installed on the standing unit 191, but may also be installed on a hanging type of punching bag or on a opponent player that is a sparring partner.

The output screen of FIG. 36 may include an effect image 167 and a statistics screen 1D1. The effect image 167 may visually represent when one player 1A strikes the punching stand 19. Although one type of effect image 167 is shown on a hit portion, the effect image 167 may be variously expressed so as to be classified according to the hit portion, a hit strength, and a speed of the hit. The statistics screen 1D1 may show various hit information such as a strength of the striking action, a speed, a switching speed between spaced motions, a reaction speed, a time point at the hit moment, changes in the above items by number of hits, or the like.

FIG. 37 is an exemplary view an output image of the combat sports scoring system according to an embodiment of the present disclosure.

The output image of FIG. 37 is an output image of the embodiment in which the sparring object 1A includes both the first and second players 1A1 and 1A2 in the system of FIG. 35. The output image may be generated by synthesizing the first scoring target image obtained by capturing the first player 1A1 and the first punching stand 19-1, the second scoring target image obtained by capturing the second player 1A2 and the second punching stand 19-2, and image information 160t corresponding to an image signal generated by the image signal generation unit 1724 of the AR server 1700.

The image information 160t may include images such as the player image, the progress image, the time image, the additional image, and the like, which are described above.

An effect 167a may be expressed so that an attack can be visually recognized when the attack is performed, and an effect 167b may be a score representing a hit strength, a speed, a point subtracted/added according to the hit strength or the speed, or the like. The effect image 167 is not limited to that shown in FIG. 37, and various pieces of information related to the striking action may be expressed in various forms (color, form, animation effect, and the like).

As described above with reference to FIGS. 26 to 37, various scoring systems may be implemented by combining the above-described combat sports system with AR, and accordingly, scoring experience that maximizes safety by reducing injuries to players is possible.

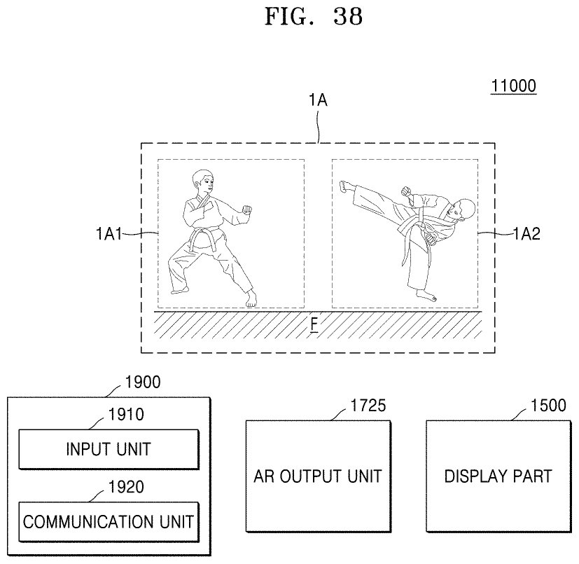

FIG. 38 is a view schematically illustrating a configuration of a combat sports scoring system according to another embodiment of the present disclosure. The same configuration as the above-described embodiments will be described with reference to the same reference numerals, and descriptions of content overlapping with those described above will be omitted or briefly given.

A combat sports scoring system 11000 may include a sparring object 1A, a controller 1900, an AR output unit 1725, and a display part 1500. The sparring object 1A, the controller 1900, the AR output unit 1725, and the display part 1500 may exchange data with each other through a network (not shown).

The sparring object 1A may include a first player 1A1 and a second player 1A2, and the players 1A1 and 1A2 may not include an electronic device such as the hit determination device 110 or the sensing unit that is described above. According to an embodiment, the sparring object 1A may include the first player 1A1 and a first punching stand 19-1 (or the second player 1A2 and a second punching stand 19-2) rather than two players 1A1 and 1A2. Here, the first player 1A1 and the first punching stand 19-1 may not include an electronic device such as the hit determination device 110 or the sensing unit that is described above.

The controller 1900 is a device that scores a state of the sparring object 1A in the match, and may include an input unit 1910 and a communication unit 1920. A match referee may evaluate a striking action of the sparring object 1A, determine a valid hit and calculate a score, and input the evaluation result through the input unit 1910. In other words, scoring information evaluated by the referee may be input through the input unit 1910. The scoring information may be transmitted to the AR output unit 1725 through the communication unit 1920. The AR output unit 1725 may generate an AR scoring image on the basis of the scoring information and transmit the AR scoring image to the display part 1500. The display part 1500 may display a scoring image including the image information 160t described above. As an example, the controller 1900 may be a device controlled by the referee.

According to the embodiment described above, it is possible to implement a combat sports scoring system that maximizes safety by generating an AR scoring image using a separate controller 1900 and not providing an electronic device to a sparring object 1A.

The embodiments according to the present disclosure described above may be implemented in the form of a computer program that can be executed through various components on a computer, and such a computer program may be recorded on a computer-readable medium. Here, the medium may be a medium that stores a computer-executable program. Examples of the medium include a magnetic medium such as a hard disk, a floppy disk, and a magnetic tape, an optical recording medium such as a compact disc read-only memory (CD-ROM) and a digital versatile disc (DVD), a magneto-optical medium such as a floptical disk, a ROM, a RAM, a flash memory, or the like which is configured to store program instructions.

Meanwhile, the computer program may be a program specially designed and configured for the present disclosure or a program known and usable to those skilled in the computer software field. Examples of the computer program include machine language codes generated by a compiler as well as high-level language codes which are executable by a computer using an interpreter or the like.

Further, while exemplary embodiments of the present disclosure have been illustrated and described, the present disclosure is not to be construed as limited to the particular embodiments described above, and it will be understood that various modifications may be made without departing from the spirit and scope of the present disclosure and such modifications are not individually understandable from the present disclosure.

### INDUSTRIAL APPLICABILITY

Accordingly, it should be noted that the spirit of the present disclosure is not limited to the embodiments described above, and it will be understood that not only the claims to be described later but also all ranges that are equivalent to or equivalently changed from the claims are within the scope of the spirit of the present disclosure.

1. A combat sports scoring system comprising: a control part configured to determine a valid hit and calculate a score on the basis of a hit signal output according to a striking action of a striking object which strikes a hit to a scoring portion of a striking target, the combat sports scoring system comprising:
a hit determination device disposed to correspond to the striking object and configured to move according to the striking action and output and transmit the hit signal including information about the striking action to the control part,
wherein the hit determination device comprises a detection antenna,
the combat sports scoring system further comprises a detection target that is provided on the scoring portion of the striking target,
the detection target comprises a memory chip in which identification information is stored and an antenna connected to the memory chip,
the detection antenna transmits a call signal for activating the detection target, the detection target transmits, in response to the call signal, a response signal including the identification information to the detection antenna, and
the detection antenna decodes the identification information on the basis of the response signal and outputs and transmits a detection signal to the control part.

2. The combat sports scoring system of claim 1, wherein
the hit determination device comprises
an inertial measurement unit (IMU) configured to output an inertial signal including three-dimensional (3D) information about the striking action, and
a communication unit configured to transmit the inertial signal received from the IMU to the control part.

3. The combat sports scoring system of claim 1, wherein
the detection antenna comprises a plurality of detection antennas, which are distinguishable from each other, respectively correspond to a plurality of striking objects.

4. The combat sports scoring system of claim 2, wherein
the control part calculates a strength of the striking action on the basis of the inertial signal and determines a form of the striking action, calculates a proximity distance between the striking object and the striking target on the basis of the detection signal, and determines the valid hit and calculates a score by applying a predetermined rule of the combat sports to the strength of the striking action, the form of the striking action, and the proximity distance.

5. The combat sports scoring system of claim 1, wherein
the detection target comprises a plurality of detection targets arranged on the scoring portion.
